(19) United States
(12) Patent Application Publication
(10) Pub. No.: US 2022/0045359 A1
(43) Pub. Date: Feb. 10, 2022

(54) MECHANICALLY ROBUST SOLID ELECTROLYTE COMPOSITIONS FOR ALKALI AND BEYOND ALKALI METAL BATTERIES

(71) Applicant: UT-Battelle, LLC, Oak Ridge, TN (US)

(72) Inventors: Jagjit Nanda, Knoxville, TN (US); Guang Yang, Ferragut, TN (US); Tomonori Saito, Knoxville, TN (US); Frank M. Delnick, Maryville, TN (US)

(21) Appl. No.: 17/397,233

(22) Filed: Aug. 9, 2021

Related U.S. Application Data
(60) Provisional application No. 63/063,454, filed on Aug. 10, 2020.

(51) Int. Cl. H01M 10/0565; H01M 10/0525

(52) U.S. Cl. CPC H01M 10/0565; H01M 2300/0085; H01M 2300/0082; H01M 10/0525

(57) ABSTRACT

A solid electrolyte (SE) composition comprising: (i) a crosslinked organic polymer containing at least one of oxygen and nitrogen atoms; (ii) an inorganic component having a metal oxide or metal sulfide composition and which is distributed throughout the crosslinked organic polymer and interacts by hydrogen bonding with the crosslinked organic polymer; and (iii) metal ions selected from the group consisting of lithium, sodium, potassium, magnesium, calcium, zinc, and aluminum. Also described herein are solid-state batteries comprising: a) an anode; (b) a cathode; and (c) the solid electrolyte composition described above. Also described herein is a method for producing the SE composition, comprising: a) homogeneously mixing the following components: (i) an organic polymer; (ii) an inorganic component; (iii) metal ions, and (iv-b) a low-boiling solvent functioning to dissolve components (i) and (iii); (b) crosslinking the organic polymer to produce a crosslinked organic polymer; and (c) removing the low-boiling solvent.

### CROSS REFERENCE TO RELATED APPLICATION

The present application claims benefit of U.S. Provisional Application No. 63/063,454, filed on Aug. 10, 2020, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention generally relates to solid electrolyte (SE) compositions for batteries, particularly lithium-based batteries. The present invention is also directed to methods for producing the solid electrolyte. The present invention is also directed to solid-state batteries, particularly lithium-based batteries containing a solid electrolyte.

### BACKGROUND OF THE INVENTION

Significant efforts continue toward the development of renewable energy sources, such as solar, wind, and tidal power combined with cost effective energy storage, such as batteries, to store power during excess generation and supply during peak demand. In this respect, development of low-cost, scalable energy storage systems with adequate cycle-life and safety is critical. Moreover, attaining high energy density without jeopardizing safety is also important to a number of applications, such as electric vehicles and consumer electronics, such as mobile phone and laptop.

Lithium- and sodium-based solid-state batteries provide a higher energy density and are inherently safe since they replace flammable liquid electrolytes with a solid electrolyte. Lithium metal anodes are known to have almost ten times the higher theoretical capacity of its graphite counterpart, and clearly can be one of the most promising disruptive technologies to advance electric vehicles and large-scale grid storage. However, there are a number of technical and scientific challenges that need to be addressed before solid-state batteries can gain widespread commercial acceptance. In particular, as further discussed below, stable cycling of lithium metal requires a chemically and interfacially stable solid-state separator with high ionic conductivity and mechanical strength.

Poly (ethylene oxide) (PEO) is an extensively studied polymer membrane material particularly in view of its stability when in contact with Li and Na metal. However, membranes composed of high molecular weight, linear PEO are known to exhibit critically low ambient temperature ionic conductivity (e.g., 10⁻⁷-10⁻⁶ S/cm) (e.g., R. E. Ruther et al., ACS Energy Letters, 3, 1640-1647, 2018). Earlier efforts have shown that conductivity can be improved by using plasticizers and/or large anion lithium salts (Ruther et al., Ibid.). However, these approaches have inevitably led to decreased mechanical rigidity and robustness (storage moduli, E′<10 MPa and shear moduli, G′<10 MPa), which results in plastic flow and lithium dendrite growth during electrochemical cycling (e.g., T. Hong et al., Macromolecules, 2019, DOI: 10.1021/acs.macromol.9b00497). Furthermore, the low melting temperature (Tₘ) of PEO (˜65° C.) inherently limits the temperature window over which these membranes can be used. Above this temperature, PEO-based electrolyte behaves like liquid, with G′<0.1 MPa. These issues significantly limit the fabrication and usefulness of PEO-based solid-state conductive membranes for such applications as redox flow cells, nonaqueous fuel cells, lithium batteries, lithium-ion batteries, and super capacitors.

Several strategies have been developed to improve the mechanical properties of the PEO-based membranes. These include: 1) covalently binding a mechanically rigid microphase (e.g., polystyrene) to the ion-conducting phase, 2) embedding inorganic fillers into a polymer matrix, 3) covalently bonding surface-modified inorganic particles to the polymer membrane, 4) incorporating the polymer into an inorganic matrix, and 5) crosslinking the PEO to increase its dimensional stability. Theoretically, the lithium dendrite growth would be suppressed if a homogeneous solid electrolyte can be used. Despite a great deal of efforts, the demonstrated mechanical rigidity in terms of the elastic modulus of currently known PEO-based electrolytes is still inadequate and several orders magnitude lower than the Li metal (1.9 to 7.9 GPa) (e.g., W. Robertson and D. Montgomery, Physical Review, 1960, 117, 440).

### SUMMARY OF THE INVENTION

In one aspect, the present disclosure is directed to a solid electrolyte (SE) composition possessing (i) suitable ionic conductivity, possibly comparable to that of liquid organic electrolytes, (ii) high electrochemical stability, and (iii) exceptional mechanical properties, particularly mechanical strength and robustness, including exceptionally high shear modulus, storage modulus, and/or elastic modulus. The SE composition includes the following components: (i) a crosslinked organic polymer containing at least one of oxygen and nitrogen atoms; (ii) an inorganic component having a metal oxide or metal sulfide composition, and which is distributed throughout the crosslinked organic polymer and interacts by hydrogen bonding with the crosslinked organic polymer; and (iii) metal ions selected from the group consisting of lithium, sodium, potassium, magnesium, calcium, zinc, and aluminum.

The present invention provides a means to achieve exceptionally high shear modulus (e.g., approx. 2.5 GPa) in polymer-based polymer electrolytes and membranes over a very broad temperature range (25° C. to 275° C.). This is accomplished by incorporating an inorganic component (e.g., glass fiber) in the polymer (e.g., a polyalkylene oxide, PAO) and crosslinking the polymer optionally in the presence of a plasticizer and/or alkaline salt. The combination of crosslinked polymer and inorganic component provides higher mechanical strength and dimensional stability at high ionic conductivity compared to existing PEO-based electrolytes, including PEO-ceramic composite electrolytes.

The substantial increase in mechanical strength in the presently described solid-state composition originates from crosslinked polymer units bonded to the surface functional groups of the inorganic component (e.g., silica fibers) through dynamic hydrogen and ionic bonding. High ionic conductivity is achieved by including a salt, e.g., lithium trifluoromethanesulfonate (LiTf), solvated in the crosslinked polymer. In the case of PEO that includes a plasticizer (e.g., tetraglyme), the anion (Tf) becomes coordinated to the PEO matrix and the Li ions become favorably coordinated to the plasticizer. Moreover, in some embodiments, the SE composition with 10 wt % plasticizer cycled in a Li-metal cell may exhibit stable cycling for more than 100 cycles for 4 months at 70° C. (1500 Coulombs/cm² Li equivalents), without dendritic growth. The SE compositions reported here can have multifunctional utility, such as solid electrolytes for solid-state batteries and membranes for redox-flow batteries.

In another aspect, the present disclosure is directed to solid-state batteries containing the above-described solid electrolyte. The solid-state battery includes: a) an anode; (b) a cathode; and (c) a solid electrolyte composition described above. In particular embodiments, the solid-state battery is a lithium-based battery and component (iii) contains lithium ions. The solid-state composites may also be integrated into thin solid electrolyte separators which are critical for solid-state batteries with high energy density. The solid-state composites may also be integrated into redox flow cells, non-aqueous fuel cells, and supercapacitors. Although the present disclosure focuses on lithium-based batteries, the SE compositions described herein are applicable to ion-type batteries beyond lithium, including alkali metal batteries (e.g., sodium and potassium), alkaline earth batteries (e.g., magnesium and calcium), and others (e.g., zinc and aluminum).

In another aspect, the present disclosure is directed to a method (also noted as a single-step method) for producing the above-described SE composition. The method includes: (a) homogeneously mixing the following components: (i) an organic polymer containing at least one of oxygen and nitrogen atoms; (ii) an inorganic component having a metal oxide or metal sulfide composition and which is distributed throughout the crosslinked organic polymer and interacts by hydrogen bonding with the crosslinked organic polymer; (iii) metal ions selected from the group consisting of lithium, sodium, potassium, magnesium, calcium, zinc, and aluminum, and (iv) a low-boiling solvent functioning to dissolve components (i) and (iii), wherein the low-boiling solvent has a boiling point of up to or less than 120° C.; (b) crosslinking the organic polymer; and (c) removing the low-boiling solvent. In some embodiments, the low-boiling solvent has a boiling point of no more than or less than 110° C. or 100° C.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1E. FIG. 1A is a schematic illustration of the single-step preparation of the glass fiber (GF) reinforced composite polymer electrolyte (CPE) based on the thermal-triggered curing process of PEGDGE and Jeffamine® at 100° C. FIG. 1B is a photograph of a free-standing crosslinked membrane containing 24 wt % LiTf with (bottom) and without (top) GF. FIG. 1C is a geometry scheme of the woven GF (top) and the GF diameter distribution (bottom). FIG. 1D is an SEM image of the cross-section of the CPE. FIG. 1E is a magnified SEM micrograph detailing the structure framed by red dash box in (d).

FIGS. 2A-2E. Mechanical property analysis of xPEO and GF reinforced CPE. FIG. 2A plots the storage modulus, E′ measured by DMA of various polymer membranes over the temperature range of 20 to 120° C. FIG. 2B plots the storage moduli, E′ of the xPEO2000 and CPE2000 over a broad temperature range of 28 to 245° C. FIG. 2C plots the stress-strain curves of the GF woven, xPEO2000 and CPE2000 samples with/without plasticizer. FIG. 2D is a magnified view of the stress-strain curves of the CPE2000 membranes with/without plasticizer in FIG. 2C. FIG. 2E is a magnified view of the stress-strain curves of the xPEO2000 membranes with/without plasticizer in FIG. 2C.

FIGS. 3A-3B. Conductivity as a function of temperature with varying molecular weight of Jeffamine® and plasticizer (FEC) loading for: dry membranes (FIG. 3A) and FEC plasticized membranes (FIG. 3B) of crosslinked PEO (xPEO) and GF reinforced membranes (CPE). The dashed lines indicate fit to the VFT model. The dark yellow line in FIG. 3B marks the xPEO2000 VFT trace for an ease of comparison with the conductivity of the dry membranes. Error bar represents the standard deviation of measurements in three different heating-cooling cycles.

FIG. 4 is a graph comparing selected CPEs developed in this study with the state-of-the-art in polymer electrolytes in terms of the ionic conductivity and shear modulus, (the number in brackets stands for the temperature in ° C.). In the graph, the bottom-left region includes crosslinked membranes, and the intermediate region includes inorganic-polymer composites and PEO-based copolymer electrolytes. Note: a-e denotes samples used in this study.

FIGS. 5A-5B. FIG. 5A is a DSC thermogram for PEO2000 series polymer membranes. FIG. 5B summarizes the T_{g} transition trend among different polymer membranes.

FIGS. 6A-6C. IR spectra of the PEO2000 series membrane in the frequency regions for —NH stretching (vNH) (FIG. 6A), and —SO₃ symmetric stretch (vₛSO₃) and CF₃ stretch (vs_{CF3}) (FIG. 6B). FIG. 6C compares the CF₃ asymmetric stretch (v_{as CF3}) between the CPE600+10 wt % FEC and CPE2000+10 wt % FEC. All IR peaks were normalized against the intensity of the C—H stretching band centered at 2871 cm⁻¹.

FIGS. 7A-7E. FIG. 7A is an optical micrograph of the cross-section of the CPE2000 membrane. FIG. 7B is a K-means analysis of the Raman mapping in the same region of FIG. 7A, showing the distribution of the five clusters of the spectra. FIG. 7C is a K-cluster centroid spectrum taken from three different regions marked in FIG. 7B. FIGS. 7D and 7E are schematic illustrations of the interaction between xPEO and the woven GF through hydrogen bonding (FIG. 7D) and Li⁺ cation-mediated ionic bonding (FIG. 7E). A tertiary amine is depicted for illustration in FIG. 7E, but the ionic bonding also applies to primary and secondary amines. R represents the aliphatic hydrocarbon groups.

FIGS. 8A-8E. Electrochemical performance of various crosslinked membranes evaluated using symmetric Li|membrane|Li cell at 70° C. The linear PEO-LiTf (with EO:Li⁺=12:1 mol) membrane was used as a reference. FIG. 8A shows voltage profiles of lithium plating/stripping cycling with va current density of 112 μA/cm² for PEO2000 membrane series with 10 wt % FEC and the linear PEO membrane. FIG. 8B shows voltage profiles of the xPEO2000 plasticized by 10 wt % TEGDME with a current density of 112 μA/cm² for the first 1811 hours and 168 μA/cm² for the subsequent 1269 hours. SEM micrographs are provided showing the surface morphology of the cycled Li electrode for linear PEO electrolyte (FIG. 8C), CPE2000+10 wt % FEC (FIG. 8D), and CPE2000+10 wt % TEGDME (FIG. 8E).

FIGS. 9A-9D. FIG. 9A shows charge/discharge profiles 75° C. of the Li metal/CPE2000+10 wt % TEGDME/LiFeO₄ cell showing selected curves from the first 100 cycles at C/15, and the initial scan at C/10, C/5 and C/2, respectively. FIG. 9B shows the discharged capacity-cycle number plot showing the cell cycling stability at C/15 for 100 scans and the rate performance at different C-rates. FIGS. 9C and 9D are photos showing the bendable pouch-type cell powering an LED light at once-folded (FIG. 9C) and triple-folded (FIG. 9D) conditions at 25° C.

### DETAILED DESCRIPTION OF THE INVENTION

In one aspect, the present disclosure is directed to a solid electrolyte (SE) composition containing (i) a crosslinked organic polymer, (ii) an inorganic component distributed throughout the crosslinked organic polymer and interacts by hydrogen bonding with the crosslinked organic polymer, and (iii) metal ions selected from lithium, sodium, potassium, magnesium, calcium, zinc, and aluminum. In some embodiments, the SE composition further includes (iv) a high-boiling solvent functioning as a plasticizer of the crosslinked organic polymer, wherein the high-boiling solvent has a boiling point of at least 120° C.

The crosslinked organic polymer generally includes at least one of oxygen and nitrogen heteroatoms in order for the crosslinked polymer to interact by hydrogen bonding with the inorganic component. Functional groups in the crosslinked organic polymer also endow the polymer with a high lithium-ion (or other ionic) conductivity. The crosslinked organic polymer is a solid, even in the absence of the inorganic component. The term “crosslinked,” as used herein, refers to a polymer containing linear portions interconnected by linking portions throughout the polymer. The resulting crosslinked polymer may have a two-dimensional or three-dimensional structure. The term “organic polymer,” as used herein, refers to a polymer containing carbon atoms. In some embodiments, the organic polymer more specifically includes carbon-hydrogen groups (e.g., methyl, methylene, or methine groups). The oxygen atoms (if present) in the organic polymer are included in oxygen-containing functional groups in the polymer, such as carbonyl, carboxyl (carboxylic acid or carboxyl ester), hydroxy, ether (linear or cyclic), and carbonate (linear or cyclic) groups, wherein the polymer may, in some embodiments, contain one, two, or more of such oxygen-containing groups and possibly not other such groups. The nitrogen atoms (if present) in the organic polymer are included in nitrogen-containing functional groups, such as amino (primary, secondary, and/or tertiary), imino, piperidinyl, and pyridinyl groups, wherein the polymer may, in some embodiments, contain one, two, or more of such nitrogen-containing groups and possibly not other such groups.

In some embodiments, the organic polymer contains oxygen atoms and not nitrogen atoms, or nitrogen atoms and not oxygen atoms. In some embodiments, the organic polymer contains both oxygen and nitrogen atoms, which may be included in separate functional groups, or alternatively, in functional groups containing both types of atoms, such as amide, urea, and carbamate (urethane) groups. In some embodiments, one or more additional types of heteroatoms (atoms other than carbon and hydrogen), other than oxygen and nitrogen atoms, may be included in the polymer, such as one or more of sulfur, silicon, and halogen atoms (e.g., fluorine, chlorine, or bromine atoms). In other embodiments, one or more additional heteroatoms are excluded.

The crosslinked organic polymer may be, for example, a crosslinked version of a polyether (including polyalkylene oxides), vinyl-addition polymer (e.g., PMA, PMMA, or PEGDMA), polyester, polyurethane, polycarbonate, polynitrile, polyol, polyamine, polysiloxane, or polyimide. Methods for crosslinking these and numerous other types of polymers are well known in the art.

In a particular set of embodiments, the crosslinked organic polymer is or includes a polyalkylene oxide (PAO) that has been crosslinked by crosslinking between functional groups on separate PAO chains. The PAO can be any of the polyether polymer compositions well known in the art. The crosslinked PAO has a sufficiently high molecular weight and degree of crosslinking to be a solid at room temperature. The molecular weight of the PAO is typically at least or greater than 500 g/mol, 1000 g/mol, 5000 g/mol, 10,000 g/mol, 50,000 g/mol, or 100,000 g/mol (weight-average or number-average). The PAO polymer generally contains a multiplicity (generally at least or more than 10, 20, 30, 40, or 50) of carbon-oxygen-carbon (ether) groups in the backbone of the polymer. In some embodiments, the polyether polymer may or may not contain ether groups in the backbone but contains a multiplicity of ether groups in side chains, such as poly(ethylene glycol)methacrylate (PEGMA), which is also an example of a branched polyether polymer. For purposes of the invention, a branched polyether polymer should contain at least two, three, four, five, six, or more ether groups in each side chain to qualify as a PAO or PEO polymer. In some embodiments, the polyether polymer does not contain ether groups in side chains or is not a branched polymer.

In the case of homopolymers, the polyalkyleneoxide segments in the PAO generally possess the formula —(CH₂CHR—O)ₙ—, wherein n is typically at least or greater than 10, 20, 50, 100, 200, 500, 1000, or 5000 and R is typically H or a hydrocarbon group, such as methyl or ethyl. The PAO may be or include, for example, polyethylene oxide (PEO) or propylene oxide (PPO). The PAO may alternatively be denoted as a glycol, such as a polyethylene glycol (PEG), polypropylene glycol (PPG), or polybutylene glycol (PBG). In some embodiments, the PAO is a copolymer (e.g., diblock, triblock, alternating, or random) or a mixture of at least two different PAOs, such as PEO mixed with PPO. In the case of copolymers, the PAO contains at least two different types of polyether units, each within the scope of —(CH₂CHR—O)ₙ—, e.g., a PEO-PPO diblock copolymer of the formula —(CH₂CH₂—O)ₙ—(CH₂CH(CH₃)—O)ₘ— or a PEO-PPO-PEO or PPO-PEO-PPO triblock copolymer. In some embodiments, the PAO may be or include polybutylene oxide (PBO), i.e., where R in the formula above is ethyl, or alternatively, PBO may correspond to —(CH₂CH₂CH₂CH₂—O)ₙ— (polytetrahydrofuran). In some embodiments, the PAO is a copolymer or a mixture of PBO and any of PEO and/or PPO. Typically, the PAO contains only one or more PAOs, i.e., without being copolymerized with or mixed with a non-polyether. In other embodiments, the PAO is copolymerized with or mixed with a non-polyether, such as polystyrene (PS), butadiene, or a polyester (e.g., polyethylene terephthalate), such as a PEO-b-PS, PEO-polybutadiene-PEO, or PEO-PET copolymer.

The inorganic component (component ii) has a metal oxide or metal sulfide composition and is distributed throughout the crosslinked organic polymer. In some embodiments, the inorganic component has an interconnected fibrous structure. The interconnected fibrous structure may be, for example, woven or non-woven. In other embodiments, the inorganic component is composed of individual particles not connected with each other. The individual particles may have any shape. Some examples of particle shapes include fibers, plates, spheres (full and flattened), and polyhedrons. The term “metal”, as used herein, can refer to any element selected from main group, alkali, alkaline earth, transition metal, and lanthanide elements. Thus, the metal oxide or metal sulfide may be a main group metal oxide or sulfide, alkali metal oxide or sulfide, alkaline earth metal oxide or sulfide, transition metal oxide or sulfide, or lanthanide metal oxide or sulfide. Some examples of main group metal oxide compositions include SiO₂ (e.g., glass or ceramic), B₂O₃, Ga₂O₃, SnO, SnO₂, PbO, PbO₂, Sb₂O₃, Sb₂O₅, and Bi₂O₃. Some examples of alkali metal oxides include Li₂O, Na₂O, K₂O, and Rb₂O. Some examples of alkaline earth metal oxide compositions include BeO, MgO, CaO, and SrO. Some examples of transition metal oxide compositions include Sc₂O₃, TiO₂, Cr₂O₃, Fe₂O₃, Fe₃O₄, FeO, Co₂O₃, Ni₂O₃, CuO, Cu₂O, ZnO, Y₂O₃, ZrO₂, NbO₂, Nb₂O₅, RuO₂, PdO, Ag₂O, CdO, HfO₂, Ta₂O₅, WO₂, and PtO₂. Some examples of lanthanide metal oxide compositions include La₂O₃, Ce₂O₃, and CeO₂. In some embodiments, mixed metal oxides (mixed composition of any of the above-mentioned metal oxides) are hierarchically assembled. In some embodiments, any one or more classes or specific types of the foregoing metal oxides (or all metal oxides) are excluded from the hierarchical assembly. Analogous metal sulfide compositions can be derived by substitution of oxide (O) with sulfide (S) in any of the exemplary metal oxide compositions recited above (e.g., SiS₂, Li₂S, or CaS).

In one embodiment, the inorganic (metal oxide or metal sulfide) component is present in the form of particles. The particles can be of any suitable size, typically up to 100 microns. In different embodiments, the metal oxide or metal sulfide particles have an average size or substantially uniform size of precisely or about, for example, 0.01, 0.05, 0.1, 0.2, 0.3, 0.4 0.5, 0.6, 0.7, 0.8, 1, 2, 5, 10, 20, 50, or 100 microns, or an average size or substantially uniform size within a range bounded by any two of the foregoing values, e.g., 0.01-10 microns, wherein the term “about” generally indicates no more than ±10%, ±5%, or ±1% from an indicated value. In some embodiments, at least 80%, 85%, 90%, 95%, 98%, or 99% of the particles have a size within any range bounded by any two of the exemplary values provided above. For example, at least 90% of the particles may have a size within a range of 0.1-10 microns or at least or more than 95% of the particles may have a size within a range of 0.1-20 microns, 0.01-10 microns, 0.1-5 microns, or 0.1-1 micron. In some embodiments, 100% of the particles have a size with a desired size range. In the case of fibers, which may be interconnected (and either woven or non-woven), the fibers may have a diameter corresponding to any of the particle sizes or ranges thereof, as described above.

The inorganic component is typically present in an amount of at least 0.1 wt % of the solid electrolyte composition. In different embodiments, the inorganic component is present in an amount of precisely or about, for example, 0.1, 0.2, 0.5, 1, 2, 3, 4, 5, 10, 15, 20, 25, 30, 40, 45, or 50 wt %, or an amount within a range bounded by any two of the foregoing values (e.g., 0.1-50 wt %, 0.1-40 wt %, 0.1-30 wt %, 0.1-20 wt %, 0.1-10 wt %, 1-50 wt %, 1-40 wt %, 1-30 wt %, 1-20 wt %, 1-10 wt %, 0.1-5 wt % or 1-5 wt %).

The metal ion (component iii) is in the form of a metal salt, which is not a metal oxide or metal sulfide. The type of metal ion incorporated into the SE composition is typically a metal ion useful in an ion battery or redox battery (e.g., lithium ions for a lithium-ion battery). The metal ion may be, for example, one or more of lithium, sodium, potassium, magnesium, calcium, zinc, and aluminum. The counteranion of the metal salt may be essentially any anion, and may be inorganic or organic, provided that the anion does not interfere with the functioning of a battery or other device in which the SE composition is incorporated. Some examples of inorganic counteranions include the halides (e.g., chloride, bromide, or iodide), hexafluorophosphate (PF₆⁻), hexachlorophosphate (PCl₆⁻), perchlorate, chlorate, chlorite, perbromate, bromate, bromite, iodate, aluminum fluorides (e.g., AlF₄⁻), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆″), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₀²⁻ and B₁₂H₁₂²⁻), perrhenate, permanganate, ruthenate, perruthenate, and the polyoxometallates, or any of the counteranions (X) provided above for the ionic liquid. Some examples of organic counteranions include the fluorosulfonimides (e.g., (CF₃SO₂)₂N⁻), fluorosulfonates (e.g., CF₃SO₃⁻, CF₃CF₂SO₃⁻, CF₃(CF₂)₂SO₃⁻, CHF₂CF₂SO₃⁻, and the like), carboxylates (e.g., formate, acetate, propionate, butyrate, valerate, lactate, pyruvate, oxalate, malonate, glutarate, adipate, decanoate, and the like), sulfonates (e.g., CH₃SO₃⁻, CH₃CH₂SO₃⁻, CH₃(CH₂)₂SO₃⁻, benzenesulfonate, toluenesulfonate, dodecylbenzenesulfonate, and the like), organoborates (e.g., BR₁R₂R₃R₄⁻, wherein R₁, R₂, R₃, R₄ are typically hydrocarbon groups containing 1 to 6 carbon atoms), dicyanamide (i.e., N(CN)₂⁻), and the phosphinates (e.g., bis-(2,4,4-trimethylpentyl)-phosphinate). In some embodiments, any one or more classes or specific types of counteranions, as provided above, are excluded from the solid electrolyte composition.

In some embodiments, the SE composition further includes a high-boiling solvent (component iv-a) functioning as a plasticizer of the crosslinked organic polymer, wherein the high-boiling solvent contains at least one of oxygen and nitrogen atoms and has a boiling point of at least 120° C. The high-boiling solvent typically has the ability to complex with or solvate the metal ion. The high-boiling solvent is either dissolved within the crosslinked organic polymer or homogeneously dispersed at the microscale or nanoscale level throughout the SE composition. In different embodiments, the high-boiling solvent has a boiling point of precisely, at least, or above, for example, 120° C., 125° C., 130° C., 135° C., 140° C., 145° C., 150° C., 155° C., 160° C., 170° C., 180° C., 190° C., 200° C., 210° C., 220° C., 230° C., 240° C., or 250° C., or a boiling point within a range bounded by any two of the foregoing values (e.g., 120-250° C., 130-250° C., 140-250° C., 145-250° C., 150-250° C., or 160-250° C.). The high-boiling solvent is typically a liquid at a temperature of 20° C., 25° C., or 30° C., in addition to being a liquid at higher temperatures. Thus, the melting point of the high-boiling solvent liquid is generally up to or below 0° C., 10° C., 15° C., 20° C., 25° C., or 30° C. The high-boiling solvent typically has a molecular weight of at least or above 70 g/mol. In different embodiments, the high-boiling solvent has a molecular weight of at least or above 70, 80, 90, 100, 110, 120, 130, 140, 150, 160, 170, 180, 190, or 200 g/mol.

The high boiling point solvent is typically present in the SE composition in an amount of 0.1-10 wt % by weight of the toughened polyester composite. In different embodiments, the high boiling point solvent is present in the SE composition in an amount of, for example, 0.1, 0.2, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, or 10.0 wt %, or an amount within a range bounded by any two of the foregoing values (e.g., 0.5-10 wt %, 1-10 wt %, 0.5-8 wt %, 1-8 wt %, 0.5-6 wt %, 1-6 wt %, 0.5-5 wt %, 1-5 wt %, 0.1-2 wt %, 0.5-2 wt %, 0.1-1.5 wt %, or 0.1-1 wt %).

In one set of embodiments, the high-boiling solvent (plasticizer) is an ether solvent. The ether solvent may be an acyclic or cyclic ether solvent. Some examples of high-boiling acyclic ether solvents include diglyme (bis(2-methoxyethyl) ether), triglyme (triethylene glycol dimethyl ether), tetraglyme (tetraethylene glycol dimethyl ether), ethylene glycol monomethyl ether, ethylene glycol dimethyl ether, ethylene glycol diethyl ether, ethylene glycol monophenyl ether, ethylene glycol diphenyl ether, propylene glycol monomethyl ether, propylene glycol dimethyl ether, diethylene glycol monomethyl ether, triethylene glycol monomethyl ether, tetraethylene glycol monomethyl ether, dipropylene glycol methyl ether, dipropylene glycol dimethyl ether, pentaethylene glycol dimethyl ether, hexaethylene glycol dimethyl ether, 2-ethoxyethyl acetate, propylene glycol methyl ether acetate (PGMEA), and diphenyl ether. The acyclic ether solvent may or may not also be fluorinated, or more particularly, perfluorinated. Some examples of fluorinated acyclic ether solvents for solvent component (iii) include 1,1,2,2-tetrafluoroethyl-2,2,3,3-tetrafluoropropyl ether, bis(2,2,2-trifluoroethyl)ether, perfluoro-1,2-dimethoxyethane, and perfluorodiglyme. Some examples of high-boiling cyclic ether solvents include 12-crown-4 and 15-crown-S.

In another set of embodiments, the high-boiling solvent (plasticizer) is an alcohol solvent. Some examples of high-boiling alcohol solvents include ethylene glycol, propylene glycol, diethylene glycol, triethylene glycol, tetraethylene glycol, pentaethylene glycol, hexaethylene glycol, and glycerol.

In another set of embodiments, the high-boiling solvent (plasticizer) is a sulfoxide solvent. Some examples of sulfoxide solvents include dimethyl sulfoxide, ethyl methyl sulfoxide, diethyl sulfoxide, methyl propyl sulfoxide, and ethyl propyl sulfoxide.

In another set of embodiments, the high-boiling solvent (plasticizer) is a sulfone solvent. Some examples of sulfone solvents include methyl isopropyl sulfone (MiPS), propyl sulfone, butyl sulfone, tetramethylene sulfone (sulfolane), methyl phenyl sulfone, phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl)ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone).

In another set of embodiments, the high-boiling solvent (plasticizer) is an amide solvent. Some examples of amide solvents include formamide, N,N-dimethylformamide, N,N-diethylformamide, acetamide, dimethylacetamide, diethylacetamide, gamma-butyrolactam, and N-methylpyrrolidone.

In another set of embodiments, the high-boiling solvent (plasticizer) is a carbonate solvent, which may an acyclic or cyclic carbonate solvent. Some examples of acyclic carbonate solvents include dimethyl carbonate (DMC), ethyl methyl carbonate (EMC) diethyl carbonate, propyl methyl carbonate, dipropyl carbonate, dibutyl carbonate, diallyl carbonate, and diphenyl carbonate. Some examples of cyclic carbonate solvents include ethylene carbonate, fluoroethylene carbonate, trimethylene carbonate, propylene carbonate, 1,2-butylene carbonate, and 2,3-butylene carbonate. The carbonate solvent may or may not also be fluorinated.

In another set of embodiments, the high-boiling solvent (plasticizer) is an acyclic (linear or branched) ester solvent or cyclic ester (lactone) solvent. Some examples of such acyclic ester solvents include n-butyl acetate, n-propyl propionate, n-butyl propionate, ethyl butyrate, and n-propyl butyrate. The acyclic ester solvent may or may not also be fluorinated, or more particularly, perfluorinated. Some examples of fluorinated acyclic ester solvents for solvent component (iii) include 2,2,2-trifluoromethyl acetate, 2,2,2-trifluoroethyl acetate, 2,2,2-trifluoroethyl butyrate, trifluoromethyl formate, and trifluoroethyl formate. Some examples of lactone solvents include γ-butyrolactone, α-methyl-γ-butyrolactone, β-butyrolactone,β-propiolactone, γ-valerolactone, δ-valerolactone, α-bromo-γ-butyrolactone, γ-phenyl-γ-butyrolactone, ε-caprolactone, γ-caprolactone, δ-caprolactone, γ-octanolactone, γ-nanolactone, γ-decanolactone, and δ-decanolactone. The cyclic ester solvent may or may not also be fluorinated, or more particularly, perfluorinated. An example of a fluorinated cyclic ester solvent for solvent component (iii) is α-fluoro-ε-caprolactone.

In another set of embodiments, the high boiling point solvent (plasticizer) is a silicon-containing solvent, e.g., a siloxane solvent. In some embodiments, the siloxane solvent is, or alternatively includes one or more dimethylsiloxane or methylhydrosiloxane units, both of which are well known in the art. Some examples of siloxane solvents include octamethyltrisiloxane (b.p. of about 153° C.) and hexaethyldisiloxane (b.p. of about 234° C.). In different particular embodiments, the siloxane solvent may be fluorinated (e.g., poly(3,3,3-trifluoropropylmethylsiloxane, nonafluorohexylmethylsiloxane, or tridecafluorooctylmethylsiloxane, typically as copolymers with dimethylsiloxane units), or may contain phenyl groups (e.g., phenylmethylsiloxane-dimethylsiloxane copolymer), or may contain longer chain alkyl groups than methyl (e.g., ethyl, propyl, butyl, pentyl, hexyl, heptyl, octyl, octadecyl, triacontyl, e.g., polydiethylsiloxanes and octadecylmethylsiloxane-dimethylsiloxane copolymer). The siloxane solvent may also be a hydrophilic silicone, such as a polyalkylene oxide silicone, e.g., dimethylsiloxane-ethylene oxide block/graft copolymers. The PDMS or PMHS may also be polar, such as (N-pyrrolidonepropyl)-methylsiloxane-dimethylsiloxane copolymer, polytetrahydrofurfuryloxypropylmethylsiloxane, or polycyanopropylmethylsiloxane.

In yet other embodiments, the high-boiling solvent (plasticizer) may be hexamethylphosphoramide (HMPA), 1,3-dimethyl-3,4,5,6-tetrahydro-2(1H)-pyrimidinone (DMPU), acetylacetone, and 1,3-diaminopropane. In some embodiments, any one or more classes or specific types of high-boiling solvents described anywhere above in the present disclosure are excluded from the solid electrolyte composition. In other embodiments, any two or more high-boiling solvents described anywhere above in the present disclosure are combined to form a mixture or solution of solvents.

In some embodiments, the SE composition described above is in the shape of a film. The produced film generally has a thickness of no more than or less than 200 microns. In different embodiments, the film has a thickness of about, up to, or less than, for example, 0.5, 1, 5, 10, 20, 25, 30, 40, 50, 60, 70, 80, 90, 100, 120, 150, 180, or 200 microns or a thickness within a range bounded by any two of the foregoing values (e.g., 0.5-50 microns, 0.5-30 microns, 0.5-25 microns, 0.5-20 microns, 1-50 microns, 1-30 microns, 1-25 microns, or 1-20 microns). In some embodiments, the separator thickness is substantially uniform, such as by having a roughness less than a micron or so.

In another aspect, the present disclosure is directed to a method for producing the SE composition described above. In some embodiments, the method is referred to as a single-step method since all components being used to produce the SE composition can be mixed at one time before undergoing crosslinking. In the method, in a first step (step a), components (i)-(iii), as described above, along with a low-boiling solvent (component iv-b) having a boiling point of less than 120° C., are homogeneously mixed so that components (i), (iii), and (iv-b) form a liquid solution and component (iii) is evenly dispersed throughout the liquid solution. The low-boiling solvent functions to dissolve components (i) and (iii). A high-boiling solvent (component iv-a), as described in detail earlier above, may optionally be included as a component to be homogeneously mixed with the other components. Methods for homogeneously mixing components in a liquid medium are well known in the art and any such method may be used. In some embodiments, the low-boiling solvent has a boiling point of up to or less than 110° C., 105° C., 100° C., 95° C., 90° C., 85° C., 80° C., 75° C., 70° C., 65° C., 60° C., 55° C., 50° C., 45° C., or 40° C., or a boiling point within a range bounded by any two of the foregoing values. In order for the low-boiling solvent to dissolve components (i) and (iii), the low-boiling solvent typically contains at least one of oxygen and nitrogen atoms. In some embodiments, the low-boiling solvent has a molecular weight up to or less than, for example, 200 g/mol, 150 g/mol, 100 g/mol, 75 g/mol, or 50 g/mol. The low-boiling solvent may be or include, for example, an alcohol (e.g., methanol, ethanol, n-propanol, or isopropanol), acetonitrile, propionitrile, acetone, diethyl ether, diisopropyl ether, tetrahydrofuran, dimethoxyethane, methylene chloride, chloroform, dimethyl carbonate, ethyl methyl carbonate, methyl acetate, ethyl acetate, or water. In some embodiments, any one or more classes or specific types of low-boiling solvents described above are excluded from the solid electrolyte composition. In other embodiments, any two or more low-boiling solvents described above are combined to form a mixture or solution of solvents.

In a second step (step b) of the method, the organic polymer in the liquid solution/homogeneous dispersion produced in step (a) is crosslinked to result in a crosslinked organic polymer as described earlier above. Methods for crosslinking a diverse range of polymers, such as any of the organic polymers (e.g., PAOs) described earlier above, are well known in the art. Typically, the organic polymer possesses at least two crosslinkable functional groups per polymer strand. The crosslinkable functional groups may undergo a crosslinking reaction directly between them, or the crosslinkable functional groups may undergo a crosslinking reaction with a crosslinking molecule different than the organic polymer, wherein the crosslinking molecule possesses at least two functional groups capable of crosslinking with functional groups on the organic polymer. When a crosslinking molecule is used, the crosslinking molecule is typically included as one of the components in step (a). The crosslinking molecule, which may be referred to as component (v), can be homogeneously mixed with components (i)-(iv-a) and optionally component (iv-b). The ratio of functional groups in the organic polymer to functional groups in the crosslinking molecule should be at least or about, for example, 1.5:1, 2:1, 2.5:1, or 3:1 to ensure that the crosslinking molecule crosslinks between different strands of the organic polymer.

The crosslinking may be induced or triggered by any of the means known in the art, including exposure to a thermal source, electromagnetic source (e.g., ultraviolet), or catalyst, or by simple reaction at room temperature with no exposure to a source. For example, in the case of the organic polymer being a PAO, such as polyethylene oxide, the PAO may be functionalized with at least two epoxide groups per PAO strand, and the epoxide-functionalized PAO may be reacted with a crosslinking molecule (e.g., hydrocarbon or PAO linker) functionalized with two or more functional groups reactive with epoxy groups (e.g., amino groups, hydroxy groups, or carboxylic acid groups). Any of the other types of organic polymers described above may be functionalized with epoxy groups and crosslinked in the same manner. Alternatively, the PAO polymer (or other polymer) may be functionalized with amino groups, and the amino-functionalized polymer may be reacted with a crosslinking molecule functionalized with two or more functional groups reactive with amino groups (e.g., carboxylic acid, carboxylic acid ester, acyl, acyl chloride, alkyl halide, anhydride, isocyanate, or epoxy groups). Alternatively, the PAO polymer (or other polymer) may be functionalized with carboxylic acid ester groups, and the ester-functionalized polymer may be reacted with a crosslinking molecule functionalized with two or more functional groups reactive with ester groups (e.g., alcohol or amino groups). Alternatively, the PAO polymer (or other polymer) may be functionalized with hydroxy groups, and the hydroxy-functionalized polymer may be reacted with a crosslinking molecule functionalized with two or more functional groups reactive with hydroxy groups (e.g., ester, epoxy, or isocyanate groups). Alternatively, the PAO polymer (or other polymer) may be functionalized with methacrylate groups, and the methacrylate-functionalized polymer may be crosslinked with itself by exposure to ultraviolet radiation, or the methacrylate-functionalized polymer may be crosslinked with a crosslinking molecule containing unsaturated groups (e.g., divinylbenzene or divinyl siloxane or silane) by exposure to ultraviolet radiation.

In a third step (step c) of the method, the low-boiling solvent is removed. The term “removed,” as used herein, generally indicates substantial removal of the solvent, except possibly for a trace of solvent that may remain as co-crystallized solvent. Generally, at least 99%, and more typically at least 99.5%, 99.9%, or 100% of the low-boiling solvent is removed. The solvent removing process may employ heating, reduced pressure (vacuum), or a combination of both to remove the solvent. The low-boiling solvent may be removed by exposure of the crosslinked composition produced in step (b) to an elevated temperature (e.g., 50, 60, 70, 80, 90, or 100° C.) for a suitable period of time (e.g., at least 12, 24, 36, or 48 hours).

Notably, in some embodiments, directly after step (a), the resulting liquid solution/homogeneous dispersion may be cast into a mold or onto a flat or textured surface to form a film of the liquid solution/homogeneous dispersion. Once cast, the liquid solution/homogeneous dispersion produced in step (a) can be subjected to crosslinking conditions followed by solvent removal.

In another aspect, the present disclosure is directed to batteries in which any of the above described ionically conductive compositions is incorporated as a solid electrolyte. The battery contains at least an anode, a cathode, and the solid electrolyte in contact with or as part of the anode and/or cathode. In some embodiments, the solid electrolyte is incorporated in the battery in the form of particles, typically as a film or membrane containing particles, as described above. In other embodiments, the solid electrolyte is incorporated in the battery in the form of a continuous film or membrane, as described above. In the battery, the particles or film of solid electrolyte can have any of the compositions, particle sizes, particle shapes, film morphologies, or film thicknesses, as described above, and combined selections thereof, as desired. In some embodiments, the lithium-based battery is a lithium metal (plate) battery, in which the anode contains a film of lithium metal. In other embodiments, the battery is a metal ion battery, in which the anode contains metal ions stored in a base material (e.g., lithium ions intercalated in graphite). Whether the battery contains a metal anode or metal-ion anode, the battery may be a single-use (primary) or rechargeable (secondary) battery.

In a particular embodiment, the battery is a lithium-based single use or rechargeable battery. Any of the solid electrolyte compositions described above can be incorporated as a solid electrolyte in contact with at least one of the anode (negative electrode) and cathode (positive electrode) of the lithium metal or lithium-ion battery. Alternatively, the solid electrolyte composition can be incorporated into a cathode of the battery (typically admixed with a binder material), and the anode and cathode may be in contact with the above-described solid electrolyte composition or any of the conventional liquid (e.g., polar solvent or aqueous) or solid electrolytes known in the art. The lithium metal battery may contain any of the components typically found in a lithium metal battery, such as described in, for example, X. Zhang et al., Chem. Soc. Rev., 49, 3040-3071, 2020; P. Shi et al., Adv. Mater. Technol., 5(1), 1900806 (1-15), January 2020; and X.-B. Cheng et al., Chem. Rev., 117, 15, 10403-10473 (2017), the contents of which are incorporated herein by reference. In some embodiments, the lithium metal battery contains molybdenum disulfide in the cathode. The lithium-ion battery may contain any of the components typically found in a lithium-ion battery, including positive (cathode) and negative (anode) electrodes, current collecting plates, a battery shell, such as described in, for example, U.S. Pat. Nos. 8,252,438, 7,205,073, and 7,425,388, the contents of which are incorporated herein by reference in their entirety. In some embodiments, the lithium-ion battery is more specifically a lithium-sulfur battery, as well known in the art, e.g., L. Wang et al., Energy Environ. Sci., 8, 1551-1558, 2015, the contents of which are herein incorporated by reference. In some embodiments, any one or more of the above noted components may be excluded from the battery.

In embodiments where the inventive solid electrolyte is in contact with an anode and cathode of the lithium-based battery but not incorporated into the cathode, the positive (cathode) electrode can have any of the compositions well known in the art, for example, a lithium metal oxide, wherein the metal is typically a transition metal, such as Co, Fe, Ni, or Mn, or combination thereof, or manganese dioxide (MnO₂), iron disulfide (FeS₂), or copper oxide (CuO). In some embodiments, the cathode has a composition containing lithium, nickel, and oxide. In further embodiments, the cathode has a composition containing lithium, nickel, manganese, and oxide, or the cathode has a composition containing lithium, nickel, cobalt, and oxide. Some examples of cathode materials include LiCoO₂, LiMn₂O₄, LiNiCoO₂, LiMnO₂, LiFePO₄, LiNiCoAlO₂, and LiNiₓMn₂O₄ compositions, such as LiNi_{0.5}Mn_{1.5}O₄, the latter of which are particularly suitable as 5.0V cathode materials, wherein x is a number greater than 0 and less than 2. In some embodiments, one or more additional elements may substitute a portion of the Ni or Mn. In some embodiments, one or more additional elements may substitute a portion of the Ni or Mn, as in LiNiₓCo₁₋ₓPO₄, and LiCuₓMn₂₋ₓO₄, materials (Cresce, A. V., et al., Journal of the Electrochemical Society, 2011, 158, A337-A342). In further specific embodiments, the cathode has a composition containing lithium, nickel, manganese, cobalt, and oxide, such as LiNiMnCoO₂ or a LiNi_{w-y-z}Mn_{y}Co_{z}O₂ composition (wherein w+y+z=1), e.g., LiNi_{0.8}Mn_{0.1}Co_{0.1}O₂. The cathode may alternatively have a layered-spinel integrated Li[Ni_{1/3}Mn_{2/3}]O₂ composition, as described in, for example, Nayak et al., Chem. Mater., 2015, 27 (7), pp. 2600-2611. To improve conductivity at the cathode, conductive carbon material (e.g., carbon black, carbon fiber, or graphite) is typically admixed with the positive electrode material. In some embodiments, any one or more of the above types of positive electrodes may be excluded from the battery.

In the lithium-based battery, the negative (anode) electrode may be lithium metal or a material in which lithium ions are contained and can flow. For lithium-ion batteries, the anode may be any of the carbon-containing and/or silicon-containing anode materials well known in the art of lithium-ion batteries. In some embodiments, the anode is a carbon-based composition in which lithium ions can intercalate or embed, such as elemental carbon, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The carbon-based anode is typically at least 70 80, 90, or 95 wt % elemental carbon. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may alternatively be a metal oxide, such as tin dioxide (SnO₂), titanium dioxide (TiO₂), or lithium titanate (e.g., Li₂TiO₃ or Li₄Ti₅O₁₂), or a composite of carbon and a metal oxide. In other embodiments, the anode may be composed partially or completely of a suitable metal or metal alloy (or intermetallic), such as tin, tin-copper alloy, tin-cobalt alloy, or tin-cobalt-carbon intermetallic. In some embodiments, any one or more of the above types of negative electrodes may be excluded from the battery.

In the event of the battery being an alkali-ion or other ion-type battery, the negative (anode) electrode of the battery may be a carbon-based composition in which alkali or other ions can be stored (e.g., intercalated or embedded), such as elemental carbon, or more particularly graphite (e.g., natural or artificial graphite), petroleum coke, carbon fiber (e.g., mesocarbon fibers), or carbon (e.g., mesocarbon) microbeads. The anode may be at least 70 80, 90, or 95 wt % elemental carbon. The negative electrode may alternatively be a metal oxide, such as tin dioxide (SnO₂) or titanium dioxide (TiO₂), or a composite of carbon and a metal oxide.

The positive and negative electrode compositions may be admixed with an adhesive (e.g., PVDF, PTFE, and co-polymers thereof) in order to be properly molded as electrodes. Typically, positive and negative current collecting substrates (e.g., Cu or Al foil) are also included. The solid electrolyte composition is typically incorporated in the form of film having any of the thicknesses described earlier above. The film of solid electrolyte is typically made to be in contact with at least one (more typically both) of the electrodes. The assembly and manufacture of lithium-based batteries are well known in the art.

In another particular embodiment, the battery is a sodium metal or sodium-ion battery in which any of the solid electrolyte compositions described above can be incorporated, either in contact with or as part of the anode and/or cathode. Any of the sodium-containing compositions described above can be incorporated as a solid electrolyte in contact with the anode (negative electrode) and cathode (positive electrode) of the sodium-based battery. Alternatively, any of the sodium-containing compositions described above can be incorporated into a cathode of the sodium-based battery (typically admixed with a binder material), and the anode and cathode in contact with any of the above-described inventive solid electrolytes or any of the liquid or solid electrolytes known in the art. Sodium metal batteries are well known in the art, such as described in, for example, H. Sun et al., Nature Communications, 10, 3302, 2019, the contents of which are herein incorporated by reference. Sodium-ion batteries are also well known in the art, such as described in, for example, U.S. Application Publication No. 2012/0021273, and B. L. Ellis, et al., Current Opinion in Solid State and Materials Science, 16, 168-177, 2012, the contents of which are herein incorporated by reference in their entirety. In embodiments where the inventive solid electrolyte is in contact with an anode and cathode of the sodium-based battery but not incorporated into the cathode, the sodium-based battery may employ, for example, a sodium inorganic material as the active material in the cathode. Some examples of sodium inorganic materials include, for example, NaFeO₂, NaMnO₂, NaNiO₂, and NaCoO₂. Other cathode materials for sodium-based batteries include transition metal chalcogenides, such as described in U.S. Pat. No. 8,906,542, and sodium-lithium-nickel-manganese oxide materials, such as described in U.S. Pat. No. 8,835,041, the contents of which are herein incorporated by reference in their entirety.

In another embodiment, the battery is a magnesium or calcium metal battery or Mg-ion or Ca-ion battery in which any of the solid electrolyte compositions described above can be incorporated, either in contact with or as part of the anode and/or cathode. In the Mg-based or Ca-based battery, any of the Mg-containing or Ca-containing ionically conductive compositions described above, respectively, can be incorporated as a solid electrolyte in contact with the anode (negative electrode) and cathode (positive electrode) of the Mg-based or Ca-based battery. Alternatively, any of the Mg-containing or Ca-containing compositions described above can be incorporated into a cathode of the Mg-based or Ca-based battery, and the anode and cathode in contact with any of the above-described inventive solid electrolytes or any of the liquid or solid electrolytes known in the art.

Magnesium metal batteries are well known in the art, such as described in, for example, S.-B. Son et al., Nature Chemistry, 10, 532-539, 2018, the contents of which are herein incorporated by reference. Magnesium-ion batteries are also well known in the art, such as described in, for example, M. M. Huie, et al., Coordination Chemistry Reviews, vol. 287, pp. 15-27, March 2015; S. Tepavcevic, et al., ACS Nano, DOI: 10.1021/acsnano.5b02450, Jul. 14, 2015; Beilstein J. Nanotechnol., 5, 1291-1311, 2014; and U.S. Pat. No. 9,882,245, the contents of which are herein incorporated by reference in their entirety. The magnesium battery may contain any of the components typically found in a magnesium battery, including cathode (positive) and anode (negative) electrodes, current collecting plates, and a battery shell, such as described in, for example, U.S. Pat. Nos. 8,361,661, 8,722,242, 9,012,072, and 9,752,245, the contents of which are incorporated herein by reference in their entirety. The positive electrode can include, as an active material, for example, a transition metal oxide or transition metal sulfide material, such as the composition MₓMo₆T₈, wherein M is at least one metal selected from alkaline earth and transition metals, T is selected from at least one of sulfur, selenium, and tellurium, and x is a value of 0 to 2. The negative electrode is generally a magnesium-containing electrode, which may include magnesium in elemental or divalent form. In elemental form, the magnesium may be either in the absence of other metals (i.e., substantially or completely pure magnesium, except for a possible trace of other metals, e.g., up to 1, 0.5, or 0.1 wt %) or in the form of a magnesium alloy, e.g., AZ31, AZ61, AZ63, AZ80, AZ81, ZK51, ZK60, ZC63, or the like. In some embodiments, the negative electrode can be or include a magnesium intercalation material, which may, before operation, not yet include magnesium intercalated therein. Some examples of magnesium intercalation materials include any of the materials described above for the positive electrode, anatase or rutile TiO₂, FeS₂, TiS₂, or MoS₂. Ca-ion batteries are also known in the art, such as described in Md. Adil et al., ACS Appl. Mater. Interfaces, 12(10), 11489-11503, 2020, the contents of which are herein incorporated by reference.

Zinc metal batteries are known in the art, such as described in, for example, F. Wang et al., Nature Materials, 17, 543-549, 2018, the contents of which are herein incorporated by reference. Zinc-ion batteries are also well known in the art, such as described, for example, in U.S. Pat. No. 8,663,844 and B. Lee et al., Scientific Reports, 4, article no. 6066 (2014), the contents of which are herein incorporated by reference. The cathode can include, for example, a composition based on manganese dioxide, and the anode may be zinc or zinc alloy. In the zinc-based battery, any of the zinc-containing ionically conductive compositions described above can be incorporated as a solid electrolyte in contact with the anode (negative electrode) and cathode (positive electrode) of the zinc-based battery. Alternatively, any of the zinc-containing compositions described above can be incorporated into a cathode of the zinc-based battery (typically admixed with a binder material), and the anode and cathode in contact with any of the above-described inventive solid electrolytes or any of the liquid or solid electrolytes known in the art.

The battery may also be an aluminum metal or aluminum-ion battery. Aluminum-ion batteries are well known in the art, such as described, for example, in U.S. Pat. No. 6,589,692 and WO 2013/049097, the contents of which are herein incorporated in their entirety. The cathode can include, for example, a graphitic, manganese oxide (e.g., Mn₂O₄), or vanadium oxide material cathode, and the anode may be aluminum or aluminum alloy. In the case of an Al-ion battery, any of the Al-containing compositions described above can be incorporated as a solid electrolyte in contact with the anode (negative electrode) and cathode (positive electrode) of the Al-ion battery. Alternatively, any of the Al-containing compositions described above can be incorporated into a cathode of the Al-ion battery (typically admixed with a binder material), and the anode and cathode in contact with any of the above-described inventive solid electrolytes or any of the liquid or solid electrolytes known in the art. The battery may analogously be a copper-based or silver-based battery, in which case any of the Cu-containing or Ag-containing ionically conductive compositions described earlier above can be incorporated as a solid electrolyte in the battery.

Examples have been set forth below for the purpose of illustration and to describe certain specific embodiments of the invention. However, the scope of this invention is not to be in any way limited by the examples set forth herein.

### Examples

Overview

Herein is reported a facile one step in-situ synthesis and fabrication of high ion-conducting glass fiber (GF) reinforced, crosslinked poly(ethylene oxide) (xPEO) composite polymer electrolyte (CPE) with exceptionally high elastic modulus (up to 2.5 GPa) over a broad temperature range (20° C.-245° C.). Such giant increase in mechanical strength originates from crosslinked PEO units bonded to the surface functional group of silica fibers through dynamic hydrogen and ionic bonding. High ionic conductivity is achieved by lithium trifluoromethanesulfonate (LiTf) salt solvated in plasticized xPEO units where the anion (Tf) units are tethered to PEO matrix and Li-ion favorably coordinated to the plasticizer (tetraglyme). Moreover, CPE with 10 wt % plasticizer cycled in a Li-metal cell showed stable cycling more than 100 cycles for 4 months at 70° C. (1500 Coulombs/cm² Li equivalents), without dendritic growth. The GF reinforced CPE reported here has multifunctional use such as solid electrolytes for all solid-state batteries and membranes for redox-flow batteries. Although focus of this study is on lithium-based batteries, the results are applicable to other alkali metal cations, such as sodium.

The above is accomplished using a one-step, crosslink reaction of the PEO in the presence of a woven glass fiber (GF). Also provided herein is a comprehensive analysis of the interaction of the polymer matrix and the GF based on micro-Raman spectroscopy and the K-clustering analysis. The results indicate that the exceptionally high mechanical strength ascribes to the strong dynamic bonding, including hydrogen bonding and ionic bonding between the polymer host and the GF guest. Further incorporation of the plasticizer increases the room temperature ionic conductivity up to 1.2×10⁻⁴ S/cm, with the storage modulus still above 450 MPa. Due to its excellent mechanical strength, such GF reinforced polymer electrolytes allow for 1498 C/cm² equivalent Li striping/plating in the course of >4 months in 70° C. using a Li metal|membrane|Li metal symmetric cell. A proof-of-concept test using a full cell configuration, composed of Li|CPE|LiFeO4 delivered >135 mAh/g capacity for 100 cycles at C/15, with a capacity loss <0.06% per cycle and Columbic efficiency close to 1 over the course of time >3 months in 70° C., demonstrating its excellent thermal and electrochemical stability in harsh conditions. The combination of high mechanical strength, dimensional stability, high ionic conductivity and electrochemical stability provides a new route of synthesizing the composite membranes for a number of electrochemical energy storage systems.

Materials

Two polymer precursors were needed for the crosslinked PEO (denoted as xPEO) membrane, namely (1) Poly(ethylene glycol) diglycidyl ether (PEGDGE, Sigma Aldrich, Mn=500 g/mol) and (2) Jeffamine® ED 600, 900 and 2000 (95% purity, Huntsman, Mn=600, 900 and 2000 g/mol, respectively). Lithium trifluoromethanesulfonate (lithium triflate, LiTf, 99.995% trace metals basis, Sigma Aldrich) was the salt in all membranes. 2-Propanol (IPA, anhydrous, 99.5%) was used. The fluoroethylene carbonate (FEC, 99%, BASF) and triethylene glycol dimethyl ether (TEGDME, ≥99%, Sigma Aldrich) were dried over molecular sieves in an inert atmosphere (O2 and H₂O<0.1 ppm) for at least 1 month before use. The woven glass fiber (Style 120 E-Glass) was purchased from Fibre Glast. All woven glass fiber was cleaned by Piranha solution (a mixture of concentrated sulfuric acid with hydrogen peroxide in a volumetric ratio of 3:1).

Membrane Fabrication

A one-step thermally triggered synthesis method was developed to fabricate the crosslinked PEO membranes. Briefly, the molar ratio of epoxides in PEGDGE to amines in Jeffamine® was fixed at 2:1 for all films. The polymers and LiTf were dissolved in 3-5 ml of IPA and mixed with a magnetic stir bar for 4 hours to allow for homogenization of the solution. The molar ratio of the Li⁺ cation to EO was fixed to 1:12. The polymer/solvent/LiTf mixture was then cast in a Teflon® dish with or without the woven glass fiber, followed by curing at 100° C. for 3 hours. All of the fabricated membranes were dried under vacuum for at least 24 hours at 65° C. to remove any residual solvent. Plasticized samples were prepared in an Ar-filled glove box by adding a designated amount of plasticizer to the membranes in a sealed 20 mL scintillation vial. For the membranes containing the woven glass fiber, the mass of plasticizer added is based on the mass of polymer in the composite (60% of total mass). The plasticizer loading was evaluated by measuring the weight difference before/after plasticization.

Cathode Preparation

Cathode fabrication was through a slurry casting method, similar to a previously reported process (L. Geng, et al., Energy Technology, 2019, 7, 1801116). Briefly, electrode slurries were prepared by mixing Lithium iron phosphate powder (LiFeO4, Hydro-Québec) Super P carbon black, and poly(vinylidene fluoride) (PVDF) (65/20/15 weight ratio) in N-methyl-2-pyrrolidone (NMP). The slurry was cast with a doctor blade onto a carbon-coated Al foil current collector and dried overnight under vacuum before preparing electrochemical cells.

Scanning Electron Microscope (SEM)

SEM micrographs were obtained by a cold-cathode field emission (FE) SEM system (Hitachi TM3030Plus Tabletop Microscope) at 15 kV accelerating voltage. The energy dispersive X-ray spectrometer (EDX) were used to obtain the elemental composition distribution of the Li anode surface (15 kV). The sample transferring time to the vacuum chamber of the SEM was less than 30 s.

Fourier-Transform Infrared Spectroscopy (FTIR)

All IR spectra were obtained from an FTIR spectrometer (Bruker, ALPHA) using a diamond attenuated total reflection (ATR) accessory. The wavenumber ranges from 4000 to 650 cm⁻¹ with 128 scans in total. All IR measurements were performed in an argon-filled glove box with O₂ and H₂O<0.1 ppm.

Raman Mapping

Before Raman measurements, samples were sealed under glass window in a custom pouch cell to prevent air exposure. Raman experiments were performed on an Alpha 300 confocal Raman spectroscope (WITec, GmbH 532 nm, objective=20×, a grating with 600 grooves/mm, numerical aperture (N.A.)=0.42, local power=300 μW). The laser spot size was approximately 1 μm. The scan region was set 60×60 μm², with the scan step size at 600 nm per pixel. The integration time was set at 3 s. Raman mappings were analyzed using Witec ProjectPlus software.

Electrochemical Methods

Ionic conductivity of the membranes was measured by electrochemical impedance spectroscopy (EIS). Membranes were punched into circular disks (diameter=1.2 cm) and sealed between two pieces of Li foil (0.95 cm) using stainless steel electrodes and heat shrink tubing to prevent moisture exposure during measurements. The impedance for each film was measured at multiple temperatures (10° C.-80° C.) over a frequency range of 1 MHz-1 Hz using a 6 mV AC signal. Samples were thermally cycled three times between 10 and 80° C. in 10° C. increments to ensure reproducibility in the impedance measurements. All EIS measurements were performed on a Biologic VMP3 potentiostat armed with EC-Lab® software. Lithium stripping and plating stability test was performed at 70° C. using a lithium foil symmetric cell in the custom stainless steel-heat shrink tubing cell cycled at a designated current density. For full cell test, a coin cell configuration composed of LFP composite cathode, a crosslinked membrane, and a lithium foil anode was used. All full cell tests were performed at 75° C.

Mechanical Property Evaluation

Films were prepared into approximately 9×5 mm specimens for mechanical analysis. Storage and loss modulus were measured by dynamic mechanical analysis (DMA) utilizing a TA Instruments Q800 DMA at an operating frequency of 1 Hz as the samples were heated from 25° C. to 120° C. at 3° C./min under nitrogen. The higher temperature (250° C.) storage modulus measurement for xPEO2000 and CPE2000 was performed at a rate of 5° C./min. Tensile measurements for the composite membranes containing woven glass fiber were performed under nitrogen at 21° C. by DMA. The composite membranes were extended at a rate of 10% strain/min until the force exerted reached 30% of the maximum tensile force. It should be noted that the composite membranes did not break. The membranes without glass fiber were elongated at a constant rate of 1 mm/min until break using an Instron 3343 universal tensile meter under ambient conditions.

Thermal Characterizations

The glass transition temperature (T_{g}) of each membrane was measured using differential scanning calorimetry (DSC, TA instruments Q2000). Samples were sealed in aluminum DSC pans in an Ar atmosphere prior to measurement. The samples were cycled at a rate of 10° C./min from −90 to 90° C. for 2 cycles. T_{g} was recorded from the second cycle.

Results and Discussion

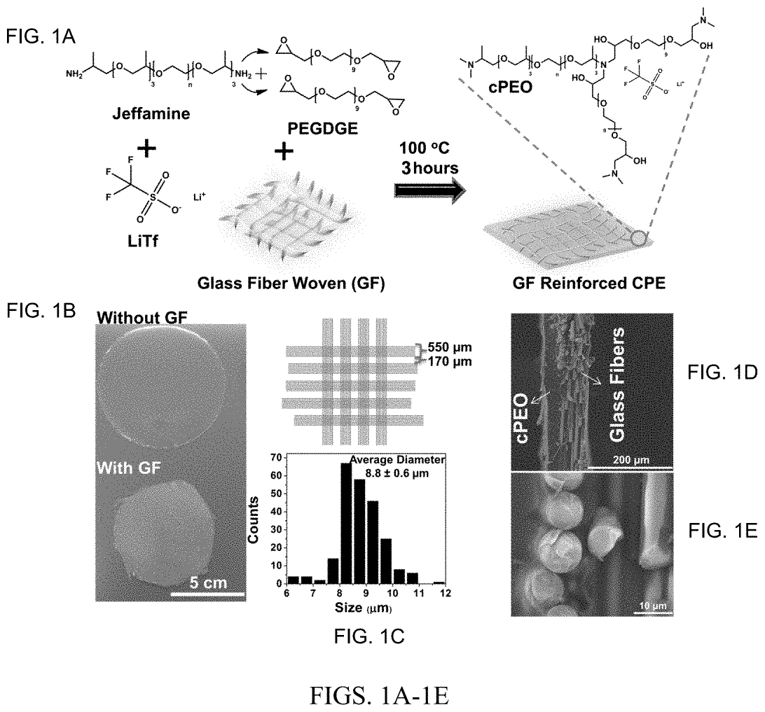

The GF reinforced composite polymer electrolyte membranes (denoted hereafter as CPE) were successfully fabricated in a facile single step, as shown in the schematic in FIG. 1A. Briefly, the woven GF was embedded in the liquid precursor containing lithium trifluoromethanesulfonate (LiTf) salt, Jeffamine®, and poly (ethylene glycol) diglycidyl ether (PEGDGE). The primary amine moiety of the Jeffamine® reacts with the epoxide on PEGDGE to form a covalent linkage triggered by the thermal activation. This one-step crosslinking reaction takes only 3 hours at 100° C., with no additional chemical process needed, demonstrating its simplicity and the great potential for future scale-up fabrication.

The crosslinked PEO (xPEO) membrane and the GF reinforced CPE cast under the same condition were uniform and flexible, as shown by the photograph of the freestanding crosslinked membrane with GF (bottom panel) and without GF (top panel) in FIG. 1B. The size of the as cast CPE is smaller than the xPEO, due to cut size of the woven GF being smaller than the casting dish and the capillary force exerted on the liquid polymer precursor during crosslinking process. The dimension of the woven GF used is shown in FIG. 1C, with the average diameter of the individual glass fibers being 8.8 The thickness of the free-standing CPE can be flexibly tuned by applying different amounts of the crosslinking chemistry precursor, and the minimum thickness of the CPE is only limited by the thickness of the woven GF itself. Two GF alignment orientations (i.e., perpendicular or parallel to the cross-section) are presented in the CPE, manifested by SEM micrographs of the cross-section, indicating the orthotropic nature of the CPE. After curing, the polymer matrix was well adhered to the GF, as indicated in the SEM images in FIGS. 1D and 1E.

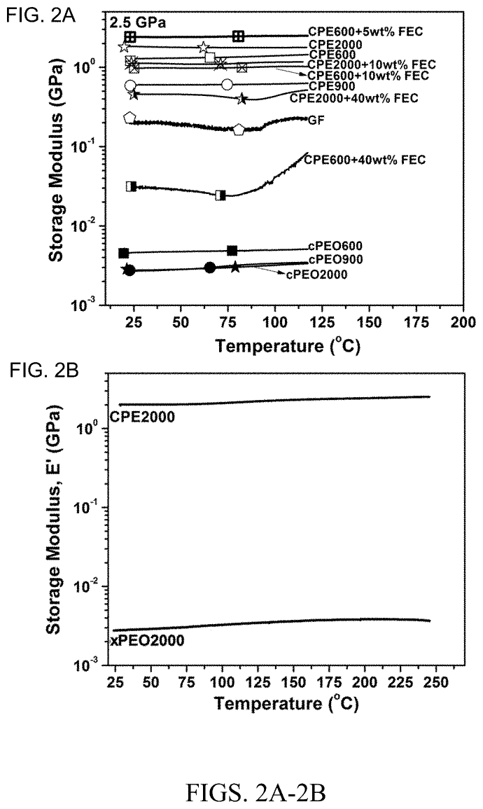

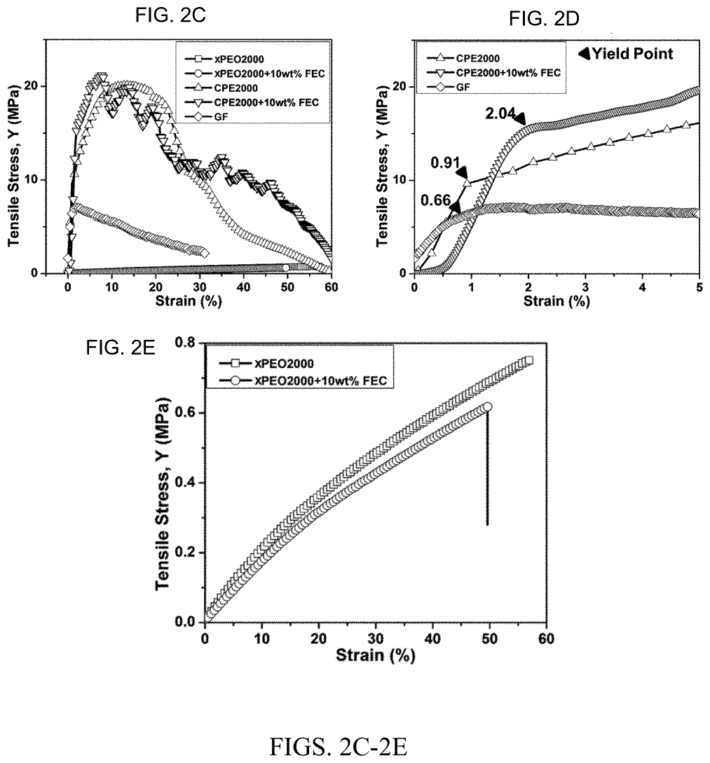

The mechanical properties of the xPEO electrolytes and GF reinforced CPE were evaluated in terms of the Young's modulus by a tensile test at room temperature and the dynamic storage modulus evaluated by DMA over a temperature range of 20 and 120° C. The results are shown in FIGS. 2A-2E.

Without the woven GF reinforcement, the storage moduli of the xPEO can be tuned by the crosslinking density of the polymer matrix. This was realized by using different molecular weights of the Jeffamine® precursor, namely 600, 900 and 2000 g/mol. The crosslinked membranes are denoted as xPEO600, xPEO900 and xPEO2000, accordingly. The crosslinking density for xPEO600, xPEO900 and xPEO2000 are 113.8 mol/m³, 109.8 mol/m³ and 48.4 mol/m³, respectively. FIG. 2A plots the storage modulus, E′ measured by DMA of various polymer membranes over the temperature range of 20 to 120° C. FIG. 2B plots the storage moduli, E′ of the xPEO2000 and CPE2000 over a broad temperature range of 28 to 245° C. As shown in FIG. 2A, a higher crosslinking density leads to a larger storage modulus (G′), which stems from the larger volumetric density of the intermolecular covalent bonds among adjacent PEO chains. Regardless, all polymer membranes without GF reinforcement (i.e., xPEO600, xPEO900 and xPEO2000) exhibited an E′ smaller than 3 MPa, which is consistent with other PEO-based crosslinked membranes. As also evident from FIG. 2A, the E′ of the woven GF is about 0.1 GPa, likely due to the loose woven GF network which deforms and pulls apart easily. While xPEO and GF themselves do not exhibit high E′ values, embedding GF woven to the xPEO leads to exceptionally high E′, reaching the gigapascal range. Such a significant increase of the E′ is not commonly observed for PEO-based electrolytes. Contrary to the non-reinforced membranes, the maximum E′ of the CPE is found for the membrane of the lowest crosslinking density (i.e., CPE2000), which implies a different mechanical enhancement mechanism for the CPE than for the xPEO.

In general, the addition of plasticizer to the CPE results in a decreasing E′. However, adding a small amount of 5 wt % FEC to CPE600 membrane led to an almost doubled E′ value (from 1.3 GPa to 2.5 GPa). Such a counter-intuitive phenomenon may result from the ionic bonding between the amine functional group of the polymer matrix with the hydroxide and siloxane functional groups on the GF.

The addition of 10 wt % FEC to CPE600 and CPE2000 slightly decreased their E′ values. Nonetheless, the resultant plasticized CPEs still have >1 GPa storage moduli. Further increasing the plasticizer loading to 40 wt % leads to a significant drop of the E′ value for CPE600. Nonetheless, CPE2000+40 wt % FEC still exhibits >450 MPa E′, outperforming other crosslinked polymer electrolyte counterparts. Notably, 40 wt % is the maximum plasticizer loading for the CPE. This indicates that even swelling with the maximum liquid electrodes, such as in a flow battery, this type of the CPEs still exhibits a satisfying combination of high mechanical strength and ionic conductivity, thus showing great potential for use in redox flow batteries.

To demonstrate the high temperature mechanical stability of the resultant membranes, dynamic mechanical analysis (DMA) was performed on the 2000-series samples over an extended temperature range. The E′ of the xPEO2000 and CPE2000 increased with increasing temperature, indicative of the mechanical stability up to at least 245° C., which is 65° C. higher than the melting point of Li metal. This demonstrates that these membranes can potentially be applied in ambient temperature lithium ion batteries, a non-aqueous flow battery where melted Li metal is used as a flowable anode at high temperatures.

The strain-stress curves of the PEO2000 samples are shown in FIGS. 2C, 2D, and 2E. FIG. 2C plots the stress-strain curves of the GF woven, xPEO2000 and CPE2000 samples with/without plasticizer. FIG. 2D is a magnified view of the stress-strain curves of the CPE2000 membranes with/without plasticizer in FIG. 2C. FIG. 2E is a magnified view of the stress-strain curves of the xPEO2000 membranes with/without plasticizer in FIG. 2C. An immediate observation is that the woven GF reinforced CPEs outperformed the crosslinked PEO, with the tensile moduli (1.19 GPa for CPE2000 and 1.25 GPa for CPE2000+10 wt % FEC) increased by 1000 folds against that of the non-reinforced xPEOs (˜2.7 MPa). As shown in FIG. 2D, the elongation at the yield point for the plasticized CPE (0.91%) is slightly lower than that of the plasticized CPE (2.04%), which indicates that the addition of a small amount of plasticizer aids in extending the elastic region of the CPE. The values of the elongation at the yield point of the composites are higher than the GF woven at 0.66%. This indicates that the polymer-GF interaction extends the elastic region in the strain-stress curve, and contributes to a better tensile modulus (YGF=0.6 GPa). The yield point elongation of the non-reinforced membranes is an order higher than the CPE, likely due to the loss of adhesion between the polymer and glass fibers, with elongation continuing to occur until after the yield point. The tensile stress at the yield point is 0.75 MPa and 0.62 MPa for non-plasticized CPE2000 and plasticized CPE2000, respectively, which is 4 to 6 times higher than a ceramic-PEO composite. The significantly higher tensile modulus of the CPE membranes than the xPEO indicates that upon embedding the woven GF, the xPEO matrix transitions from rubbery to a strong and slightly rigid material.

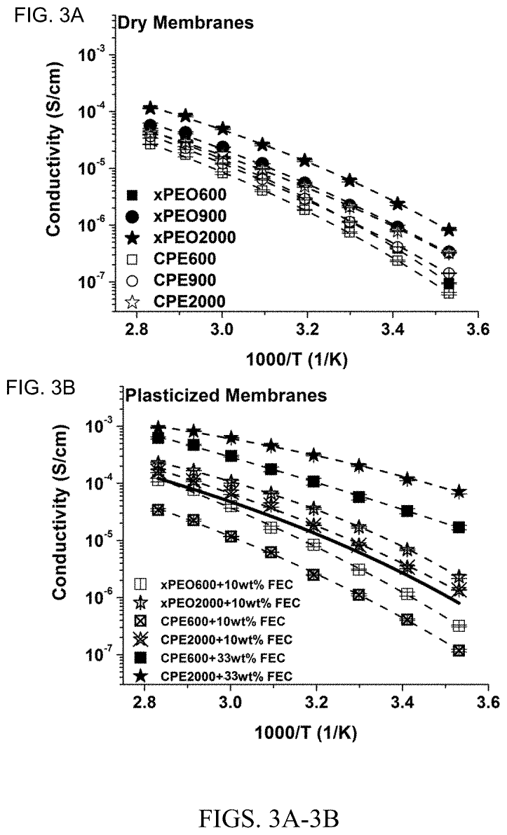

The ionic conductivity (σ) of various types of membranes over the temperature range of 10° C. to 80° C. is shown in FIGS. 3A and 3B. As shown in FIG. 3A, without plasticizer, the ionic conductivity ranges between 6.2×10⁻⁸ S/cm for CPE600 at 10° C. and 1.1×10⁻⁴ S/cm for xPEO2000 at 80° C., which is comparable with other dry PEO-based polymer electrolytes.

The ionic conductivity increases with the decrease of the crosslinking density over the temperature range studied (FIG. 3A). For example, at 80° C., the ionic conductivity increases from 4.2×10⁻⁵ S/cm for xPEO600, to 5.7×10⁻⁵ S/cm for xPEO 900, and further to 1.1×10⁻⁴ S/cm for xPEO2000. This result is ascribed to enhanced polymer chain segmental motion upon the decrease in the crosslinking per unit volume. For each xPEO, addition of the woven GF slightly decreases the ionic conductivity at each temperature. This may result from the displacement of the ion-conductive phase (i.e., the PEO phase) by the non-conductive phase (i.e. the glass).

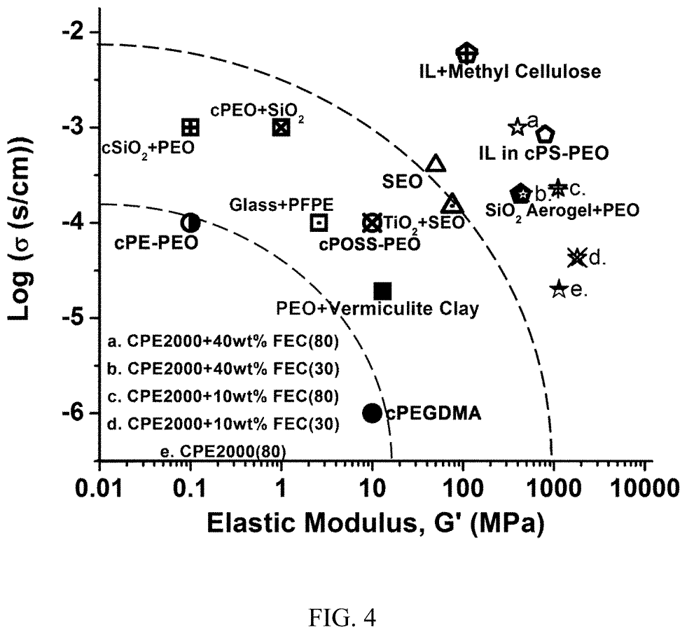

As shown in FIG. 3B, the addition of the plasticizer to each membrane significantly increases the ionic conductivity. For example, the ionic conductivity at 20° C. increases to 7.0×10⁻⁶ S/cm for xPEO2000 upon addition of the 10 wt % FEC, and further to 1.2×10⁻⁴ S/cm with 40 wt % FEC loading. The combination of the >10⁻⁴ S/cm ambient ionic conductivity and gigapascal level shear modulus sets such a CPE beyond the performance of most of reported various polymer composite electrolytes comparable to a high molecular weight polystyrene-poly (ethylene oxide) (PS-PEO) copolymer electrolytes measured at an elevated temperature (>90° C.). A detailed property comparison of the current state-of-the-art composite membranes with those developed in this study is shown in FIG. 4. It is worth emphasizing that the addition of 10 wt % FEC plasticizer results in an increase in the ionic conductivity by more than an order of magnitude without a significant decrease in the storage modulus (FIGS. 2A-2B). Therefore, the combined use of glass fiber mat reinforcement and plasticization resulted in an ionic conductivity better than the crosslinked PEO itself, with a storage modulus boosted by >1000 folds.

The ionic conductivity of all membranes can be well fit to the Vogel-Fulcher-Tammann (VFT) equation (R2>0.99) as

$$σ = {σ}_{o} exp [ \frac{- B}{R ( T - {T}_{o} )} ]$$

where σo is a pre-exponential factor (high temperature intercept), B and To are fitting parameters (B/R as the pseudoactivation energy and To as the ideal glass transition temperature). See D. T. Hallinan et al., MRS Bulletin, 43, 759-767, 2018.

The VFT parameter B for dry membranes (ranging between 7.5 and 11.7 kJ/mol) is comparable to those for other PEO-based crosslinked systems (6.0 to 10.0 kJ/mol). The general trends observed for membranes of all crosslink densities in our study are a) B increases with the incorporation of the GF to the crosslinked polymer matrix; b) B increases with small amount of plasticizer (10 wt %) but decreases with further increased plasticizer amount (40 wt %). The values of B for all xPEO membranes are ˜9 kJ/mol, comparable to those reported in a similar crosslinked polymer electrolyte system.

The mechanical rigidity and the ionic conductivity of selected CPEs developed in the current study are compared with state-of-the-art CPE counterparts reported recently. To date, several strategies have been adopted to mechanically strengthen the polymer electrolytes. In general, these methods can be categorized as follows:

1) Introducing a second rigid phase to form a block copolymer. For example, due to the high glass transition temperature (T_{g}) of polystyrene, G′ may be increased by 6 orders for a PS-b-PEO block copolymer compared to its PEO homopolymer counterpart, reaching 50 MPa with an ionic conductivity of the 10-4 S/cm at 90° C.

2) embedding nano-size fillers into the polymer matrix. For example, the mechanical strength of the PS-b-PEO block copolymer can be further increased by adding inorganic nanoparticle fillers, such as TiO₂. However, the G′ experienced only an incremental increase compared with the neat PS-b-PEO electrolytes.

3) Introducing ceramic or glass into the polymer matrix. Although ceramic fillers have a high modulus, the maximum E′ of the ceramic-polymer composite is still under 100 MPa.

4) Incorporating ionic liquid (IL) into the polymer matrix. A strategy of crosslinking a PS-b-EO copolymer in the presence of an IL may be capable of increasing the shear modulus close to 1 GPa level at RT or above.

5) Crosslinking adjacent polymer chains. Crosslinked polyethylene (PE)-PEO membrane may have a room temperature ionic conductivity at ˜10⁻⁴ S/cm and the storage modulus, E′ of 0.1 MPa, a typical modulus for rubbery polymers. Although the PE-PEO membrane may be capable of retarding lithium dendrite growth, the mechanical rigidity generally remains relatively low.

Based on the above observations, it becomes clear that the storage modulus of the woven GF reinforced polymer membranes developed in the current study is among one of the highest values, and the ionic conductivity is comparable to its state-of-the-art counterparts.

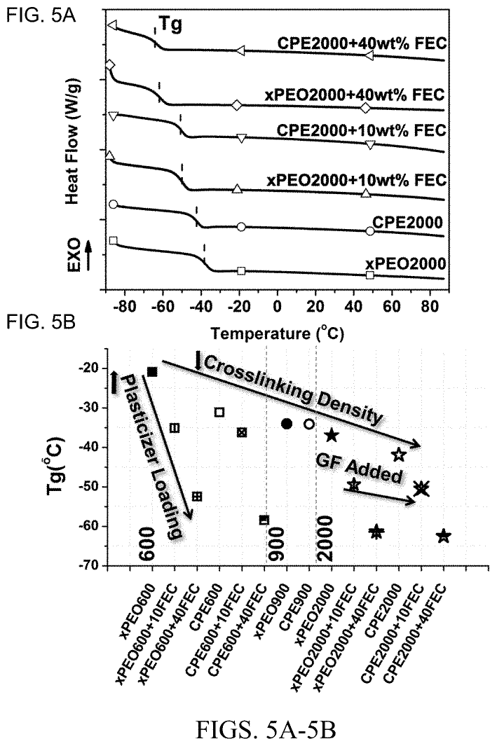

The impact of crosslinking density, addition of GF, and plasticizer on T_{g} of the various membranes by was further evaluated, and the results shown in FIGS. 5A and 5B. FIG. 5A exhibits the DSC profiles for PEO2000 membrane series. No melting peak is discernible for all membranes, which confirms the completely amorphous character of the crosslinked membranes. All PEO2000 membranes show a single endothermic transition with the glass transition upon heating, with T_{g} below −30° C., a reference value used for a linear PEO system. Addition of GF to the xPEO2000 leads to T_{g} decreasing from −37° C. to −42° C., which is indicative of the augmented local polymer chain segmental motion. As shown in FIG. 5B, a similar trend is observed for PEO600 and PEO900 series.

Addition of GF to the xPEO2000 leads to T_{g} decreasing from −37° C. to −42° C., indicative of the augmented local polymer chain segmental motion. A similar trend was observed for PEO600 and PEO900 series (FIG. 5B). The incorporation of woven GF decreases the ionic conductivity as previously shown in FIGS. 3A and 3B. This disagrees with the increased polymer segmental motion indicated by DSC thermogram. This may arise from the competition between the GF replacing the conductive PEO phase, i.e., to reduce the ionic conductivity and the GF additive resulted chain relaxation.

The T_{g} value further decreased upon the addition of plasticizer, and declined still further with increasing plasticizer amount. This arose from the promoted segmental motion of the PEO chains by the plasticizer and decreasing ionic interactions between Li⁺ and the ethylene oxide units of PEO, which contributes to the increased ionic conductivity of the plasticized membranes (FIGS. 3A and 3B). It can be seen from FIG. 5B that T_{g} increases with crosslinking density due to the restriction of chain segmental motion with increasing crosslink points per unit volume. In turn, the decreased segmental motion explains the decrease in ionic conductivity with increasing crosslinking density (FIGS. 3A and 3B).

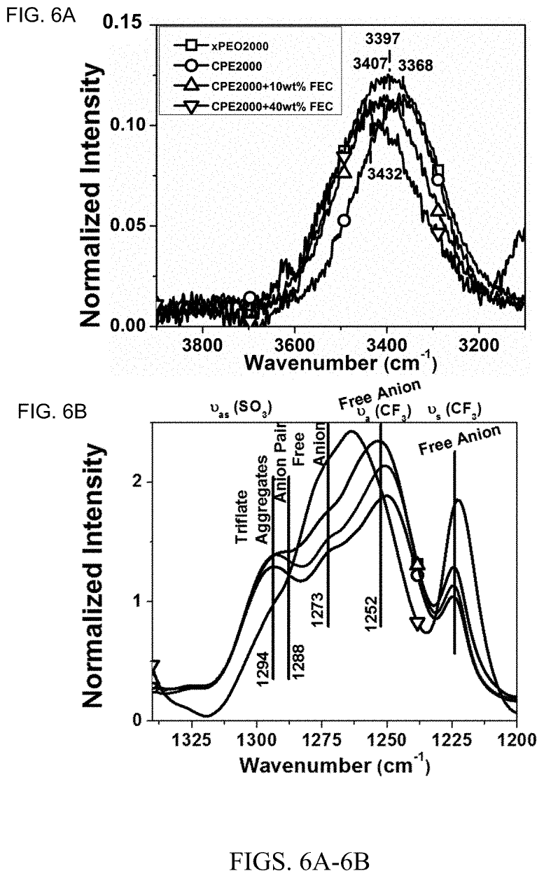

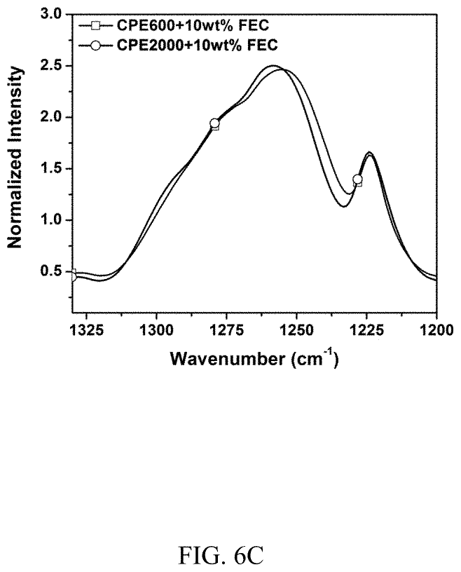

The local polymer structure and the coordination chemistry were evaluated by FT-IR, with the results provided in FIG. 6A. As shown in FIG. 6A, all plots exhibit the —NH stretching mode (vNH) between 3600 cm₋₁ and 3150 cm⁻¹. Interestingly, the center of the v_{NH} of the xPEO redshifts from 3397 cm⁻¹ to 3368 cm⁻¹ with the addition of GF to the polymer matrix. Most likely, the shift occurs from hydrogen bonding (H-bonding) between the —NH moiety and the oxide atom on the SiO₂ surface (silanol, —OH or siloxane, —Si—O—Si—). This may lead to a “slowed-down” N—H vibration motion and consequently a lower vibrational frequency. The physisorption of the surrounding polymer chains to the glass fiber mediated by H-bond contributes to the abrupt increase of the storage moduli for CPEs.

The N—H stretching mode blueshifts to a higher wavenumber of 3407 cm⁻¹ (FIG. 6A) upon addition of 10 wt % FEC plasticizer, and further blueshifts to 3432 cm⁻¹ when the plasticizer loading reaches 40 wt %. This indicates the disruption of the hydrogen bonding by addition of the plasticizer. The resultant detachment of the polymer chains from the GF surface leads to decreased E′ values (FIGS. 2A and 2B).

It is known that ion dissociation and solution solvation chemistry play a key role in polymer electrolytes (e.g., M. Huang et al., Energy & Environmental Science, 11, 1326-1334, 2018). Elucidation of the local coordination chemistry of the Li⁺ cation and the triflate anion with the PEO ether group were further provided by IR spectroscopy, as featured by several IR bands in the frequency range between 1200 cm⁻¹ and 1340 cm⁻¹. The data is shown in FIG. 6B. A single peak centered at 1224 cm⁻¹ exclusively represents the symmetric —CF stretching (vs_{CF3}) of “free” triflate anions, similar to that observed for LiTf-poly(propylene oxide) (PPO) system. The asymmetric C—F stretching band (vasCF3) centered at 1254 cm⁻¹ affirms the existence of the “free” triflate anions for all samples, although this band convolutes with the —CH₂ twisting mode of the PEO chains. The incorporation of woven GF into the xPEO matrix leads to a slight decrease of free triflate ions, indicated by a smaller intensity for vs_{CF3} and vas_{CF3} vibrational modes (FIG. 6B). However, these two bands increase in intensity upon addition of the FEC plasticizer, indicative of more free moving ions in the polymer matrix. This phenomenon is further demonstrated by the —SO₃ stretching mode of free triflate anions centered at 1273 cm⁻¹ (W. Huang et al., The Journal of Physical Chemistry, 98, 100-110, 1994). Upon increase of plasticizer loading, the free anion vas_{SO3} mode gains intensity, whereas its counterparts representing the TFS⁻ anion pair (1288 cm⁻¹) and anion aggregates (1294 cm⁻¹) decrease in intensity. In this connection, the increasing ionic conductivity by addition of plasticizer can be partly ascribed to the increase of free ions in the plasticized CPEs. It is also noteworthy that the incorporation of GF into the polymer matrix does not lead to a discernible solvation structure change measured by IR (FIG. 6B).

Another trend worth noting is that the larger molecular weight Jeffamine® precursor (PEO2000), and hence a lower crosslink density of the CPE, results in a slightly larger free ion concentration after plasticizing. This is indicated by the slight shift of the vas_{CF3} to higher frequency, as shown in FIG. 6C. The higher ionic conductivity of CPE2000+10 wt % FEC than CPE600+10 wt % FEC can then be partly ascribed to the slightly larger free ion concentration in the former membrane.

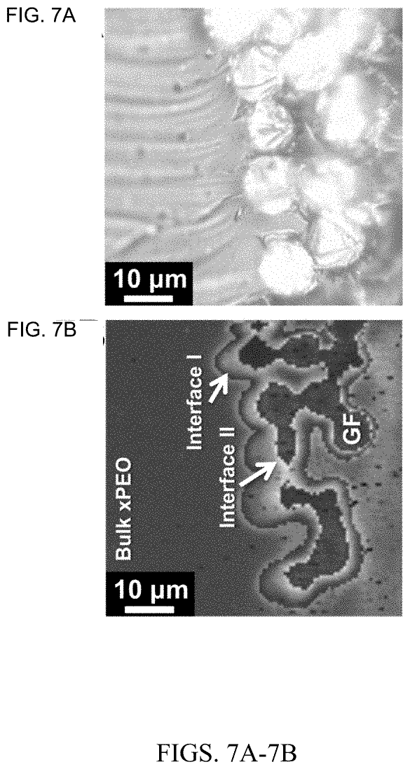

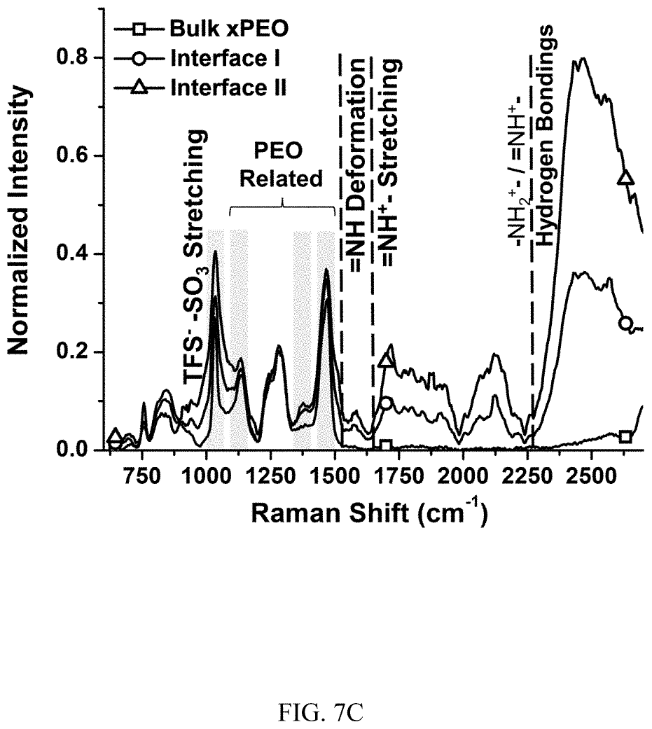

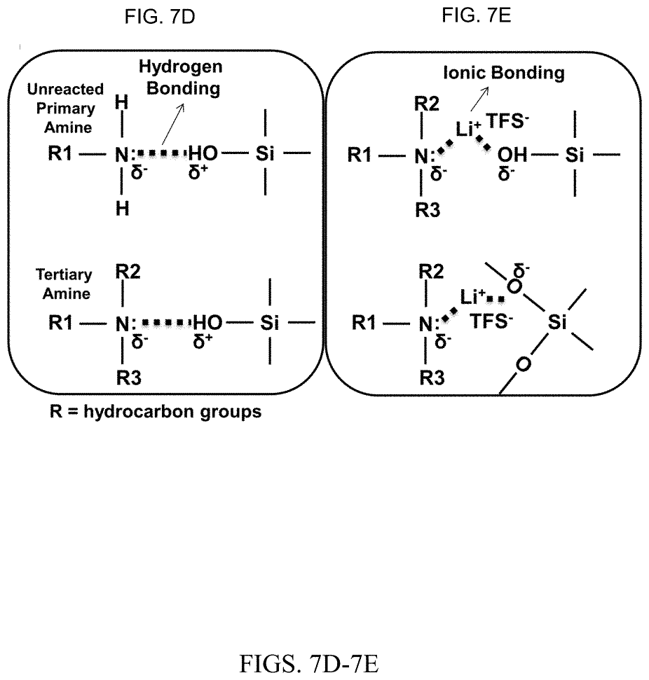

To further elucidate the site specific local coordination chemistry of the GF reinforced xPEO, the cross-sections of the CPEs were analyzed using confocal micro-Raman mapping combined with unsupervised k-means clustering analysis. FIG. 7A shows a micrograph of the CPE2000 cross-section, with the polymer and GFs distributed on the left side and right side, respectively.

A set of Raman maps were also taken of the same region as FIG. 7A to elucidate the chemical distribution of the intensity of an individual Raman band as a monovariant. The Raman maps were further analyzed by K-means algorithm. K-means analysis allows for clustering of the Raman spectra within a Raman mapping based on the similarity of all spectra, with the centroid of each cluster representing the common features of the spectra within that cluster. As shown in FIG. 7B, the 14400 spectra within the Raman map were categorized into five clusters. The spectra taken from the bulk polymer and the interfacial region (marked by Interface I and II) between the polymer and the GF clearly portioned into different clusters. A detailed comparison among the centroid spectra from the bulk polymer (xPEO) and the xPEO/GF interface is shown in FIG. 7C. An immediate observation is that a few —NH related vibrational modes increase in intensity from the xPEO bulk to the xPEO/GF interface. The most distinguished change is observed in the region between 2250 cm⁻¹ and 2700 cm⁻¹. The width and intensity of such a peak increases from Interface I to Interface II as it approaches the GF surface, ascribed to the convolution of hydrogen bonding between the amine moieties in the xPEO matrix with the hydroxide functional groups on GF surface, as depicted in FIG. 7D. This finding is further corroborated by the increase in intensity of the peaks centered at 1580 cm⁻¹ (—NH— deformation mode) and those ranging between 1800 cm⁻¹ and 2200 cm⁻¹ (—NH⁺=stretching mode) from region Interface I to Interface II. The hydrogen bonding-based mutual interaction between the xPEO matrix and GFs explains the boosted mechanical strength of the CPE with respect to its xPEO counterpart.

The K-means analysis makes evident that the interfacial Raman band gains intensity in 1034 cm⁻¹, ascribed to TFS− ion pair symmetric —SO₃ stretching mode. This indicates an increase in abundance of Li⁺-TFS− ion pairs at the xPEO/GF interface, in accordance with the EDX mapping of the F− element. These results indicate that the solvated Li⁺ forms a physical crosslinking bridge between the negatively charged nitrogen atom of the amine and oxygen of either the hydroxide or siloxane groups on the GF surface, as depicted in FIG. 7E. These physical crosslinks are an additional factor which contribute to the greatly increased mechanical strength of the composite membranes.

The change of the band centered at 1087 cm⁻¹ and 1132 cm⁻¹ may be due to the interfacial PEO conformational variation, due to the fact that these two peaks can be ascribed to the v_{CC}+va_{COC} and vs_{COC}+τs_{CH2}, respectively (B. Papke et al., Journal of Physics and Chemistry of Solids, 42, 493-500, 1981). The vibrational modes may convolute with the —CN stretching band (G. Yang et al., Langmuir, 32, 4022-4033, 2016). The conformational change of the PEO at the interface can be elucidated using the bands centered at 1376 cm⁻¹ and 1468 cm⁻¹, ascribed to ω_{sCH2}+v_{CC} mode in tgg, ggg conformational triads and δa_{CH2} in tgt triad of the PEO, respectively (t and g respectively represent the trans and gauche conformation of triads of O—C, C—C, and C—O bonds in PEO). The 1376 cm⁻¹ band increases in intensity as it approaches the polymer-GF interface, which indicates the enrichment of the gauche conformational triads of the PEO at this region. The weak band at 1578 cm⁻¹ is not associated with either PEO or the TFS− anion, it is featured as the ═NH deformation vibration of the secondary amine.

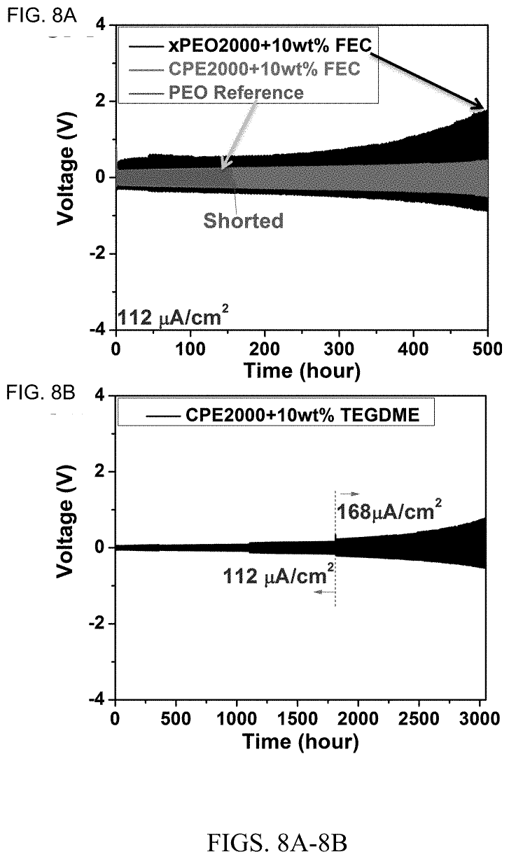

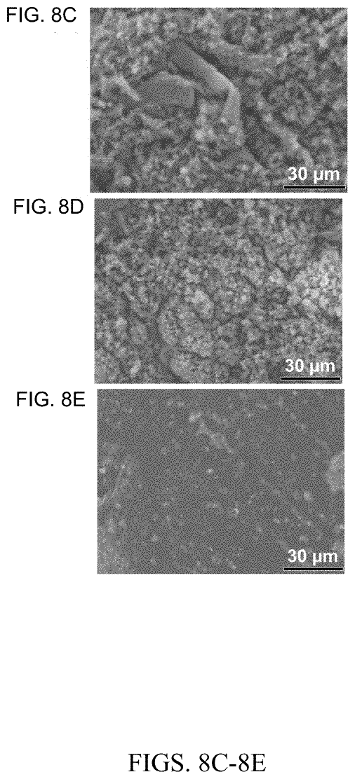

FIGS. 8A and 8B show the voltage profiles of the symmetric cells cycled at a constant current density of either 112 μA/cm² or 168 μA/cm² at 70° C. as a function of time. The symmetric cell, composed of two lithium metal electrodes with the membrane sandwiched in between, was periodically charged for 30 minutes, followed by a 30-minute discharge process. The positive voltage refers to Li stripping, whereas the negative voltage corresponds to Li plating. An immediate observation is that for the linear PEO-LiTf reference membrane, a voltage drop occurs after merely 154 hours, an indication of short circuit due to Li dendrite growth. This is further confirmed by the dendrite-like morphology in the SEM micrograph of the Li electrode surface for linear PEO-LiTf membrane (FIG. 8C). While the cycling life of the symmetric cells for FEC plasticized xPEO membranes is more than tripled, the overpotential, increased gradually as time elapsed. This phenomenon clearly suggests that the xPEO-Lithium interface is unstable under the current test conditions. A detailed view of the Li electrode surface morphology is provided in FIG. 8D. As shown, the Li electrode surface became roughened to form a “cauliflower-like” structure. Therefore, the increasing overpotential for the FEC-plasticized membranes may result from the reduction of the FEC on the continuously growing Li surface upon stripping/plating and less contact of the alkali metal surface with the polymer membranes. Clearly, the use of FEC as a plasticizer in the current polymer membrane does not homogenize the Li⁺ distribution on the anode/electrolyte interface as its liquid electrolyte counterpart does. However, it should be emphasized that no Li dendrite piercing through the membrane was observed for all FEC-plasticized xPEO or CPE membranes. As shown in FIG. 8E, Li anode cycled with plasticized CPE2000 exhibits a smooth surface.

By further replacing the FEC with an ether-based compound, tetraethylene glycol dimethyl ether (TEGDME), the cycle life of the symmetric cell drastically improves (FIG. 7B), without compromising the mechanical properties and ionic conductivity of the composite membranes. For the first 1811 hours, the overpotential remained stable at 89 mV with the current density 112 μA/cm², indicating a stable Li/polymer interface. Notably, there was a slight increase of the voltage at 1107th hour, due to a power failure. At the 1812th hour, the current density was increased by 50% to 168 μA/cm². The symmetric cell was operated for another 1269 hours, until its overpotential reached 783 mV. The increased overpotential may be due to the growing solid/liquid interface (SEI) layer on the lithium anode surface. It should be emphasized that the total amount of charge passed through the course of the testing was 1498 C/cm², which corresponds to a total amount of 1.4 mm of lithium stripping/plating, comparable to a crosslinked cPE-PEO membrane tested under similar conditions. The Li surface cycled against TEGDME-xPEO2000 is smooth, as shown in FIG. 7E. EDX spectroscopy shows less of a SEI component distributed on this electrode with respect to the FEC plasticized membrane, especially for the fluorinated species. This suggests that TEGDME as a plasticizer stabilizes the polymer/lithium interface better. Significantly, the choice of the TEGDME as a plasticizer at the same loading does not inherently affect the mechanical strength of the GF reinforced membranes and the ionic conductivity.

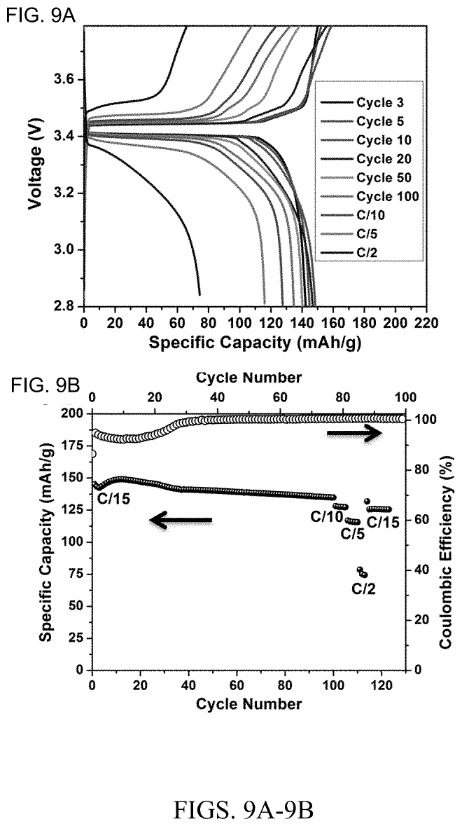

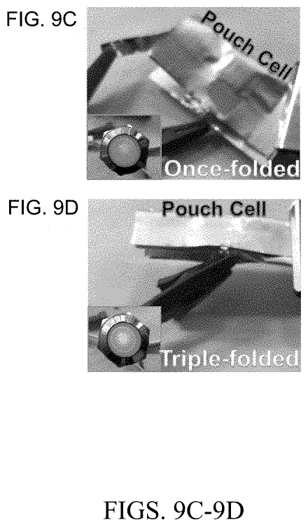

To investigate the viability of using GF strengthened CPE membranes in lithium metal batteries, a battery performance test was conducted. The composite membrane was tested in a Li metal/CPE2000+10 wt % TEGDME/LiFeO₄ (LFP) configuration at 75° C. FIG. 9A exhibits the charge/discharge profiles for 100 cycles at C/15 (assuming the theoretical capacity of 170 mAh/g for LFP), followed by various C-rates for rate performance test. The potential range was set to 2.8 V-3.8V. A plateau region at ˜3.4 V was observed for both charge and discharge processes, which represents the typical redox process of the LFP electrode. The cycling stability indicated by the discharge capacity is plotted in FIG. 9B. The initial discharge capacity was 146 mAh/g, and gradually increased to 150 mAh/g for the first 14 cycles to reach equilibrium. The excellent cycling stability for the first 100 cycles at C/15 (average capacity loss=0.059% per cycle) under harsh conditions (i.e., 75° C. for ˜94 days) demonstrates the excellent compatibility of the GF reinforced membrane with the Li metal and a cathode at elevated temperatures. The capacity dropped slightly to 128 mAh/g for C/10 rate, 116 mAh/g for C/5 rate, and to 75 mAh/g for C/2 rate. Batteries that can be charged and discharged on the time scale of 2-15 hours at moderate current density are directly relevant for backing up grid scale energy storage (e.g., peak regulation during day or night time).

The dimensional stability of the membrane in an operable pouch-type Li/CPE2000+10 wt % TEGDME/LFP cell was further demonstrated. FIGS. 9C and 9D are photos showing the bendable pouch-type cell powering an LED light at once-folded (FIG. 9C) and triple-folded (FIG. 9D) conditions at 25° C. The photos show that such a pouch cell folded once or even three times was still capable of powering the LED (3V DC). A test comparing the flame resistance of CPE2000 with a commercial Celgard separator of the same size (model 2500) was also conducted. When subjected to the flame of an igniter, the Celgard shrank in less than 3 seconds. In sharp contrast, the GF reinforced CPE lasted for over 43 seconds while still remaining intact. Thus, the CPE used in the current study has been shown to be flame retardant, which inherently improves battery safety.

The results presented herein have successfully demonstrated that woven glass fiber reinforced crosslinked polymer electrolyte (CPE) exhibit unprecedentedly high elastic moduli without sacrificing ionic conductivity. Confocal Raman microscopy supported by K-clustering analysis reveals that such ultra-high mechanical rigidity of the CPEs is due to dynamic bonding, between the GF reinforcement and the polymer matrix. A superior combination of mechanical properties, ionic conductivity, and thermal/electrochemical stability of the CPE membrane provides a Li dendrite-resistant ability at an elevated temperature. Moreover, compatibility with Li metal and cycling against a commonly used cathode (LiFeO₄) demonstrates the great potential for its integration into the current battery manufacturing process such as roll-to-roll for solid-state batteries and grid storage application.

While there have been shown and described what are at present considered the preferred embodiments of the invention, those skilled in the art may make various changes and modifications which remain within the scope of the invention defined by the appended claims.

What is claimed is:

1. A solid electrolyte composition comprising the following components:
(i) a crosslinked organic polymer containing at least one of oxygen and nitrogen atoms;
(ii) an inorganic component having a metal oxide or metal sulfide composition and which is distributed throughout the crosslinked organic polymer and interacts by hydrogen bonding with the crosslinked organic polymer; and
(iii) metal ions selected from the group consisting of lithium, sodium, potassium, magnesium, calcium, zinc, and aluminum.

2. The solid electrolyte composition of claim 1, further comprising:
(iv-a) a high-boiling solvent functioning as a plasticizer of the crosslinked organic polymer, wherein the high-boiling solvent contains at least one of oxygen and nitrogen atoms and has a boiling point of at least 120° C.

3. The solid electrolyte composition of claim 2, wherein the high-boiling solvent is an ether solvent.

4. The solid electrolyte composition of claim 1, wherein the crosslinked organic polymer comprises a polyalkylene oxide.

5. The solid electrolyte composition of claim 4, wherein the polyalkylene oxide comprises polyethylene oxide.

6. The solid electrolyte composition of claim 1, wherein the inorganic component has a metal oxide composition.

7. The solid electrolyte composition of claim 6, wherein the metal oxide comprises silicon oxide.

8. The solid electrolyte composition of claim 6, wherein the metal oxide composition is glass fiber.

9. The solid electrolyte composition of claim 8, wherein the glass fiber is woven.

10. The solid electrolyte composition of claim 8, wherein the glass fiber is non-woven.

11. The solid electrolyte composition of claim 1, wherein component (iii) comprises lithium ions.

12. The solid electrolyte composition of claim 1, wherein said solid electrolyte is in the shape of a film having a thickness of up to 200 microns.

13. A solid-state battery comprising:
a) an anode;
(b) a cathode; and
(c) a solid electrolyte composition comprising the following components:
(i) a crosslinked organic polymer containing at least one of oxygen and nitrogen atoms;
(ii) an inorganic component having a metal oxide or metal sulfide composition and which is distributed throughout the crosslinked organic polymer and interacts by hydrogen bonding with the crosslinked organic polymer; and
(iii) metal ions selected from the group consisting of lithium, sodium, potassium, magnesium, calcium, zinc, and aluminum;
wherein the solid electrolyte is in the shape of a film having a thickness of up to 200 microns.

14. The solid-state battery of claim 13, wherein the solid electrolyte further comprises:
(iv-a) a high-boiling solvent functioning as a plasticizer of the crosslinked organic polymer, wherein the high-boiling solvent contains at least one of oxygen and nitrogen atoms and has a boiling point of at least 120° C.

15. The solid-state battery of claim 13, wherein the high-boiling solvent is an ether solvent.

16. The solid-state battery of claim 13, wherein the crosslinked organic polymer comprises a polyalkylene oxide.

17. The solid-state battery of claim 16, wherein the polyalkylene oxide comprises polyethylene oxide.

18. The solid-state battery of claim 13, wherein the inorganic component has a metal oxide composition.

19. The solid-state battery of claim 18, wherein the metal oxide comprises silicon oxide.

20. The solid-state battery of claim 18, wherein the metal oxide composition is glass fiber.

21. The solid-state battery of claim 20, wherein the glass fiber is woven.

22. The solid-state battery of claim 20, wherein the glass fiber is non-woven.

23. The solid-state battery of claim 13, wherein the solid-state battery is a lithium-based battery and component (iii) comprises lithium ions.

24. A method for producing a solid electrolyte composition, the method comprising:
(a) homogeneously mixing the following components: (i) an organic polymer containing at least one of oxygen and nitrogen atoms; (ii) an inorganic component having a metal oxide or metal sulfide composition; (iii) metal ions selected from the group consisting of lithium, sodium, potassium, magnesium, calcium, zinc, and aluminum, and (iv-b) a low-boiling solvent functioning to dissolve components (i) and (iii), wherein the low-boiling solvent has a boiling point of less than 120° C.;
(b) crosslinking the organic polymer to produce a crosslinked organic polymer; and
(c) removing the low-boiling solvent;
wherein the inorganic component is distributed throughout the crosslinked organic polymer and interacts by hydrogen bonding with the crosslinked organic polymer.

25. The method of claim 24, wherein the low-boiling solvent has a boiling point of less than 100° C.

26. The method of claim 24, wherein the low-boiling solvent is an alcohol.

27. The method of claim 24, wherein the organic polymer comprises a polyalkylene oxide.

28. The method of claim 27, wherein the polyalkylene oxide comprises polyethylene oxide.
